(19) United States
(12) Patent Application Publication
(10) Pub. No.: US 2026/0077483 A1
(43) Pub. Date: Mar. 19, 2026

(54) VARIABLE STIFFNESS ACTUATOR SYSTEMS AND METHODS

(71) Applicant: PURDUE RESEARCH FOUNDATION, WEST LAFAYETTE, IN (US)

(72) Inventors: Dongming GAN, West Lafayette, IN (US); Jiaming FU, Pensacola, FL (US); Muhammad Hammad ALVI, Austin, TX (US)

(21) Appl. No.: 19/245,110

(22) Filed: Jun. 20, 2025

Related U.S. Application Data
(60) Provisional application No. 63/662,370, filed on Jun. 20, 2024.

(51) Int. Cl. B25J 9/14; A61H 1/02

(52) U.S. Cl. CPC B25J 9/142; A61H 1/0288; A61H 2201/0103; A61H 2201/1238

(57) ABSTRACT

A bendable actuator and methods for operating the bendable actuator are disclosed. Embodiments include an actuator that bends when a plurality of chambers are filled with a gas or fluid, and a stiffness beam that inhibits the bending of the actuator in the region of the actuator adjacent the stiffness beam. Some embodiments include a slider chamber in which the stiffness beam moves, and can include a closed-loop cable and motorized pulley system to selectively position the stiffness beam at different locations within the slider chamber. Additional embodiments include the plurality of chambers being vertically disposed and being connected to one another only at the lower portions of the chambers, while further embodiments include the plurality of chambers being vertically disposed and alternatingly connected at upper and lower portions of the chambers to form a sinusoidally-shaped chamber.

This application claims the benefit of U.S. Provisional Application No. 63/662,370, filed 20 Jun. 2024, the entirety of which is hereby incorporated herein by reference.

### GOVERNMENT RIGHTS

This invention was made with government support under contract no. 2131711 awarded by the National Science Foundation. The government has certain rights in the invention.

### FIELD

Embodiments of this disclosure relate generally to robotic systems, and to actuator systems, for example actuator systems used in rehabilitation.

### BACKGROUND

This section provides background information related to the present disclosure which is not necessarily prior art.

Over the past few decades, the number of stroke patients worldwide has increased. A stroke is a neurological disorder that can lead to a stroke victim developing various risk factors, such as hypertension, diabetes, hyperlipidemia, heart disease and obesity. A stroke can therefore lead to conditions that compromise various physiological functions in individuals, with impaired mobility, and in particular impaired hand mobility, significantly affecting the overall convenience of daily life. Patients with impaired functionality (e.g., hand functionality) can engage in continuous passive motion exercises to partially restore hand mobility, including repetitive tasks such as grasping and opposition motion. These exercises can be assisted and enhanced by use of rehabilitation robots. Several rehabilitation technologies, including training equipment and assistive devices, have been implemented. To date, numerous research endeavors have focused on the development of robotic devices for upper limb training in stroke patients, encompassing various wearable hand-assistive devices. Some attempts at post-stroke hand rehabilitation that have received positive feedback from patients have included lightweight and comfortable exoskeletons, and soft robotic gloves.

Currently available rehabilitation robots offer only a singular therapy focused on opening and closing motions. These therapies involve repetitive hand movements in gripping motions. Use of alternative hand rehabilitation therapies, such as those that involve high-frequency complex finger movements, can enhance hand functionality over the therapies offered by the rehabilitation robots, and may be defined as manipulating the individual metacarpal-phalangeal (MCP) joints, the proximal interphalangeal (PIP) joints, and the distal interphalangeal (DIP) joints on the four main fingers on the hand. See., e.g., FIG. 1. Rehabilitation therapies involving single joint-blocking orthosis movements inhibit the movement of a selected joint on the finger and activate the remaining ones.

Alternative hand rehabilitation therapies may provide overall better hand functional outcomes with less pain over the course of the therapy. Moreover, single joint-blocking orthosis movements are also helpful in decreasing formation of tendon adhesions within the finger joints and preserving hand mobility. FIG. 2 shows a set of proposed alternate therapies against conventional hand rehabilitation therapies. The conventional therapies consist of open and closed fists while the alternate therapy adds the straight fist, the hook fist, and the table-top first to the therapy. The alternate hand rehabilitation therapy may inhibit a single joint in the finger from moving while actuating the remaining joints.

In order to implement the alternative therapies, researchers have proposed several soft wearable exoskeletons designed for hand rehabilitation. For instance, a known system introduces a soft wearable exoskeleton using a glove embedded with pneumatic actuators of variable stiffness and capable of conforming to the finger profile during actuation. Similarly, another system provides a variable stiffness robotic glove with a multi-stage articulated elastomer providing stiffness adjustments to accommodate varying joint resistance. However, the inventors of the present disclosure realized that these soft wearable exoskeletons have limitations in providing a substantial ratio of stiffness variation.

Researchers have also explored alternative variable stiffness mechanisms, which hold potential for applications in hand rehabilitation. Such systems propose a continuum robot with a variable stiffness mechanism powered by a set of embedded shape memory alloy (SMA) springs. While its branches can bend to adapt to finger shapes, it may require extended cooling time. Other known systems demonstrate soft-rigid tendon-driven modular grippers using interpenetrating phase composite materials, but this has limited ability to achieve significant stiffness changes. Other known systems introduce a discrete variable stiffness gripper based on a fin ray structure, but this occupies a substantial amount of space with its stiffness adjustment mechanism. Additionally, other known systems may establish a variable stiffness gripper based on layer jamming, but these face challenges in easy repositioning. Other systems provide a gripper utilizing pneumatic pouch actuators to adjust adaptable flaps on flexure hinges, but it has an insufficient ratio of stiffness variation. Another known system introduces a continuous variable stiffness robotic gripper, but this is limited to single-joint applications.

Accordingly, there is a continuing need for variable stiffness actuator that may adjust the stiffness of individual portions within the actuator.

However, it was realized by the inventors of the present disclosure that a common feature amongst these rehabilitation robots is that they offer only a single type of therapy using a simple open-close motion. The new stuff accommodating multiple hand positions. Therapies requiring different hand positions are challenging to implement and, if available, require replacement of various equipment, causing inconvenience for patients.

Certain preferred features of the present disclosure address these and other needs and provide other important advantages.

### SUMMARY

Embodiments of the present disclosure provide an improved variable stiffness actuator systems and methods.

In accordance with at least one aspect of the present disclosure, a variable stiffness actuator capable of adjusting the stiffness of individual portions within the actuator is disclosed.

In accordance with other aspects of the present disclosure, a variable stiffness soft actuator (VSSA) capable of adjusting the stiffness of desired regions within the actuator is disclosed. Embodiments of the VSSA include a soft robot actuator and a slot chamber underneath the base of the actuator. The slot may include a stiffness beam that is positioned at a desired location, which can change the local stiffness within the region. The VSSA may be used on hand rehabilitation gloves that implement therapies, such as alternative rehabilitation therapies, by manipulating the stiffness of the region above the individual finger joints. The VSSA may be utilized in other rehabilitation applications independent from hand rehabilitation. The varying stiffness of the region above the joints allows the actuator to bend only in one or more desired regions. The VSSA may allow the fingers to be bent as required by various therapies, such as the alternative therapies depicted in FIG. 2. Soft actuator designs used in conventional hand rehabilitation therapies have a single degree of freedom (DOF), whereas introducing the design of the VSSA allows for varying DOF within the actuator, which enables alternative multi-joint control of fingers in hand rehabilitation therapies.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The drawings described herein are for illustrative purposes of selected embodiments and not all possible implementations. The drawings should not limit the scope of the present disclosure. Some of the figures shown herein may include dimensions or may have been created from scaled drawings. However, such dimensions, or the relative scaling within a figure, are by way of example, and not to be construed as limiting.

FIG. 1 illustrates two hand rehabilitation therapy positions.

FIG. 2 depicts four alternative hand rehabilitation therapy positions.

FIG. 3 is a-side elevational view of a variable stiffness actuator system (VSSA-1) according to at least one embodiment of the present disclosure.

FIG. 4 is a top plan view of an ASTM D683 Type IV sample used for testing of a variable stiffness actuator system according to at least one embodiment of the present disclosure.

FIG. 5 is a line graph illustrating a TPU Stress-strain curve with Mooney-Rivlin 2nd order curve fit according to at least one embodiment of the present disclosure.

FIG. 6A is a side perspective view and partial cross section of a variable stiffness actuator system showing a closed-loop stiffness beam actuation according to at least one embodiment of the present disclosure.

FIG. 6B is a cross-sectional side view of a lower portion of the variable stiffness actuator system depicted in FIG. 6A taken along line 6B-6B and showing a closed-loop stiffness beam actuation according to at least one embodiment of the present disclosure.

FIG. 7 is an enlarged view of the cross-sectional portion of FIG. 6A denoted with “Enlarged in FIG. 7” further depicting a wall thickness difference between top and bottom surfaces according to at least one embodiment of the present disclosure.

FIG. 8 is a cross-sectional side view of a variable stiffness actuator system depicting various stiffness beam configurations (e.g., locations) according to at least one embodiment of the present disclosure.

FIG. 9 is a cross-sectional perspective view of the variable stiffness actuator system VSSA-1, further depicting an FEA simulation setup, according to at least one embodiment of the present disclosure.

FIG. 10 is a side elevational view of the variable stiffness actuator system (VSSA-1), further depicting an FEA simulation mesh with refined contact mesh, according to at least one embodiment of the present disclosure.

FIGS. 11 and 12 depict the FEA simulation results of the different configurations of the variable stiffness actuator system, according to embodiments of the present disclosure.

FIG. 13 is a box diagram illustrating an experimental setup for the variable stiffness actuator system, according to at least one embodiment of the present disclosure.

FIG. 14 is a side elevational view of the variable stiffness actuator system VSSA-1 depicting final deformations achieved by the robotic system in each simulated configuration according to at least one embodiment of the present disclosure.

FIG. 15 is a series of line graphs illustrating an experimental and FEA simulation tip deformation comparison for each configuration according to embodiments of the present disclosure.

FIG. 16 is a flow chart of a method for using robotic systems (e.g., VSSA-1 and VSSA-2) according to at least one embodiment of the present disclosure.

FIG. 17 is a picture of a VSSA-2 embodiment mounted to a cloth glove according to at least one embodiment of the present disclosure.

FIG. 18 is a picture of a VSSA-2 embodiment being deformed showing sample finger actuation according to at least one embodiment of the present disclosure.

FIG. 19 is a perspective and partial cross-sectional view of a VSSA-2 embodiments according to at least one embodiment of the present disclosure.

FIG. 20 is a depiction comparing the actuators of VSSA-1 and VSSA-2 configurations according to at least one embodiment of the present disclosure.

FIG. 21 includes a side view and an end view of a VSSA-2 configuration according at least one embodiment of the present disclosure.

FIG. 22 is an exploded depiction of a mold for manufacturing a VSSA-2 actuator according to at least one embodiment of the present disclosure.

FIG. 23 is a collapsed depiction of the mold depicted in FIG. 22.

FIG. 24 is an exploded depiction of another mold for manufacturing a VSSA-2 actuator according to at least one embodiment of the present disclosure

FIG. 25 is a collapsed depiction of the mold depicted in FIG. 24.

FIG. 26 is a picture of a VSSA-2 that is partially completed after being ejected from a Mold-1 mold and depicting the positioning of a silicon tube in a Mold-2 mold.

FIG. 27 is a cross-sectional depiction of a VSSA-2 actuator showing the stiffness beam in different positions according to embodiments of the present disclosure.

FIG. 28 is a picture of a finger test stand with flexible force sensors on the MCP and PIP finger joints according to at least one embodiment of the present disclosure.

FIG. 29 is a picture showing deflection of a VSSA-2 actuator at 25 kPa according to at least one embodiment of the present disclosure.

FIG. 30 includes a depiction of a VSSA-2 actuator in Configuration 1 (no joint blocking), a finite element analysis (FEA) of the VSSA-2 in Configuration 1, and experimental results of the VSSA-2 in Configuration 1.

FIG. 31 includes a depiction of a VSSA-2 actuator in Configuration 2 (MCP joint blocking), a finite element analysis (FEA) of the VSSA-2 in Configuration 2, and experimental results of the VSSA-2 in Configuration 2.

FIG. 32 includes a depiction of a VSSA-2 actuator in Configuration 3 (PIP joint blocking), a finite element analysis (FEA) of the VSSA-2 in Configuration 3, and experimental results of the VSSA-2 in Configuration 3.

FIG. 33 is a comparison of a finite element analysis (FEA) curve, an experimental curve and an interpolated experimental curve of a VSSA-2 actuator in Configuration 1 according to at least one embodiment of the present disclosure.

FIG. 34 is a comparison of a finite element analysis (FEA) curve, an experimental curve and an interpolated experimental curve of a VSSA-2 actuator in Configuration 2 according to at least one embodiment of the present disclosure.

FIG. 35 is a comparison of a finite element analysis (FEA) curve, an experimental curve and an interpolated experimental curve of a VSSA-2 actuator in Configuration 3 according to at least one embodiment of the present disclosure.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” that may occur within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

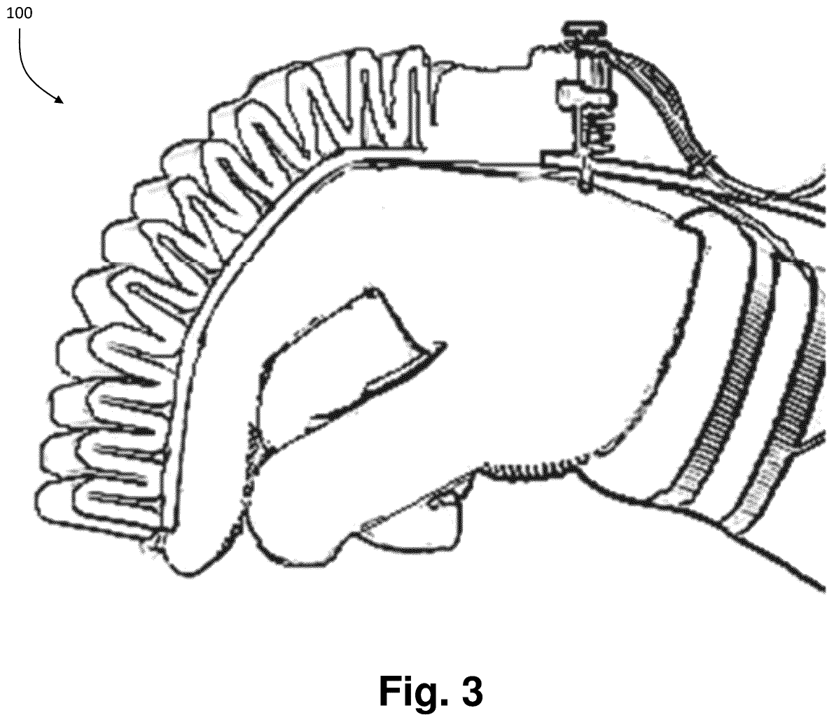

Depicted in FIGS. 3-15 are configurations of a variable stiffness actuator according to embodiments of the present disclosure. These configurations (also referred to as VSSA-1 configurations) were developed as improvements to existing therapy devices. FIG. 3 depicts at least one embodiment of a VSSA actuator 100 applied in rehabilitation therapies.

The VSSA-1 systems include an actuator portion and a slot chamber. The actuator portion may include a variable stiffness soft actuator (VSSA) and a motor. The actuator may be disposed adjacent to a surface of the slot chamber. In a specific example, the actuator may be coupled to the surface of the slot chamber. The slot chamber may be constructed from a substantially rigid material, such as 3D printed PLA or steel. The actuator may be shaped having a substantially sinusoidal wave pattern. The actuator may be constructed from a flexible material. In a specific example, the actuator may include a thermoplastic polyurethane material. In another specific example, the slot chamber may include a stiffness beam that may move within the slot chamber. The positioning of the stiffness beam may be selectively adjusted. For instance, the positioning of the stiffness beam may be adjusted through the use of the motor. More specifically, the motor may be coupled to the stiffness beam via a closed-loop cable and pulley system. The actuator may be pneumatically actuated from an air reservoir. The motor may also include an encoder which may determine a position of the stiffness beam. It is contemplated that the system of the present disclosure may be utilized in other applications beyond rehabilitation therapies. For instance, the system of the present disclosure may be utilized in any application where a device needs variable stiffnesses at different portions of an actuator. One skilled in the art may select other suitable ways to provide the system or end use applications for the system, within the scope of the present disclosure.

In certain circumstances, the system may include a controller. The controller may be configured to engage and disengage the system. For instance, the controller may adjust the position of the stiffness beam and/or adjust an amount of air pressure to the actuator. A skilled artisan may select other suitable ways to control the system, within the scope of the present disclosure.

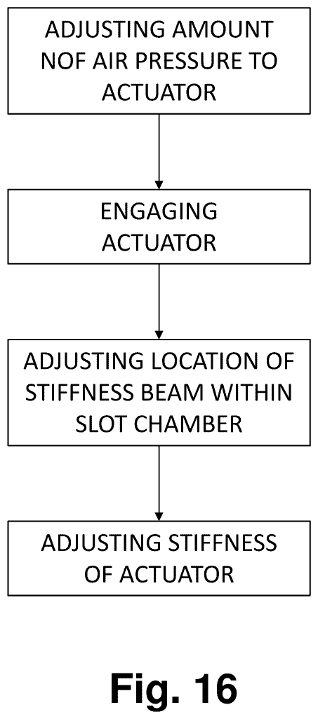

In certain circumstances, the system of the present disclosure may be provided in various ways. For instance, the system may be used according to a method. As shown in FIG. 16, the method may include a step of adjusting an amount of air pressure to the actuator. Then, the actuator may be engaged. The method may also include a step of adjusting the location of the stiffness beam within the slot chamber. Next, the stiffness of the actuator may be adjusted. In a specific example, a first portion of the actuator may be adjusted to have a first stiffness and a second portion of the actuator may be adjusted to have a second stiffness, and the first stiffness may have a greater magnitude of force than the second stiffness. One skilled in the art may select other suitable ways to use the system, within the scope of the present disclosure.

Provided as a non-limiting example, the system of the present disclosure was provided and analyzed according to the following parameters.

The VSSA-1 was constructed using additive manufacturing technology of 3D printing. The material used was the “Filaflex TPU” with a shore hardness of 60 A. Thermoplastic Polyurethane (TPU) is a flexible material that can be used for 3D printed applications. The design was fabricated using a modified 3D printer extruder head which has dual contact regions on the filament extruder head, allowing the material to be pulled uniformly. The uniform forces applied on the flexible material militate against it from jamming the extruder head during the printing process.

The flexible 3D printing filament from Filaflex may be formed from a class of material polymers from polyurethane. The material may be naturally a high-elasticity plastic which allows it to be deformed in a manner such as bending and flexing easily. The flexing behavior of the material may be labeled as a hyper-elastic material.

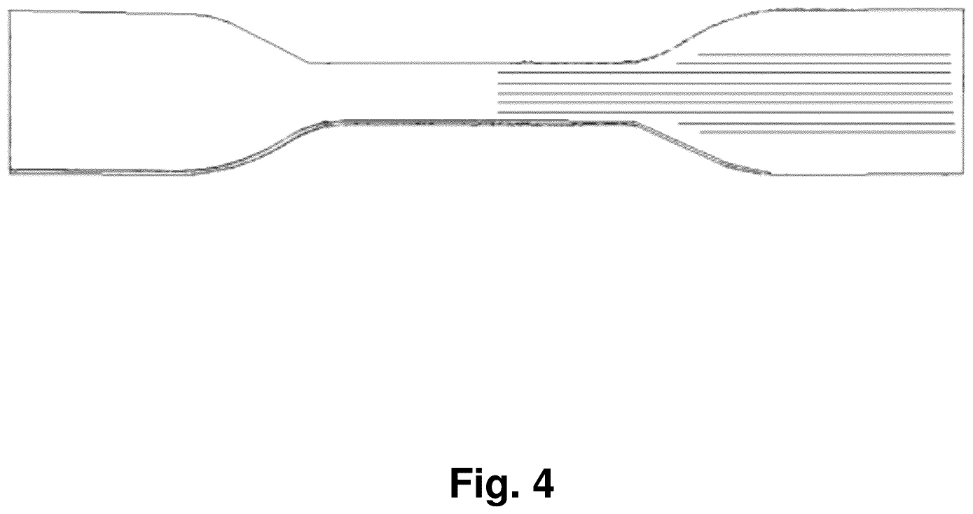

Creating a functional design to perform accurate simulations of the actuator design may require the material's stress-strain curve to be mapped in a simulation software. A uniaxial tensile test was conducted to map the stress-strain curve of the material selected for the VSSA-1. Four samples of ASTM D638 type IV, as shown in FIG. 4, were used for the test and fabricated using 3D printing. The test specimens were printed at a 100% infill with the print line orientation set to the longitudinal axis of the test. The tests were conducted on the Universal Force Testing Systems (Instron 34SC-5) with a constant extension rate of 50 mm/min.

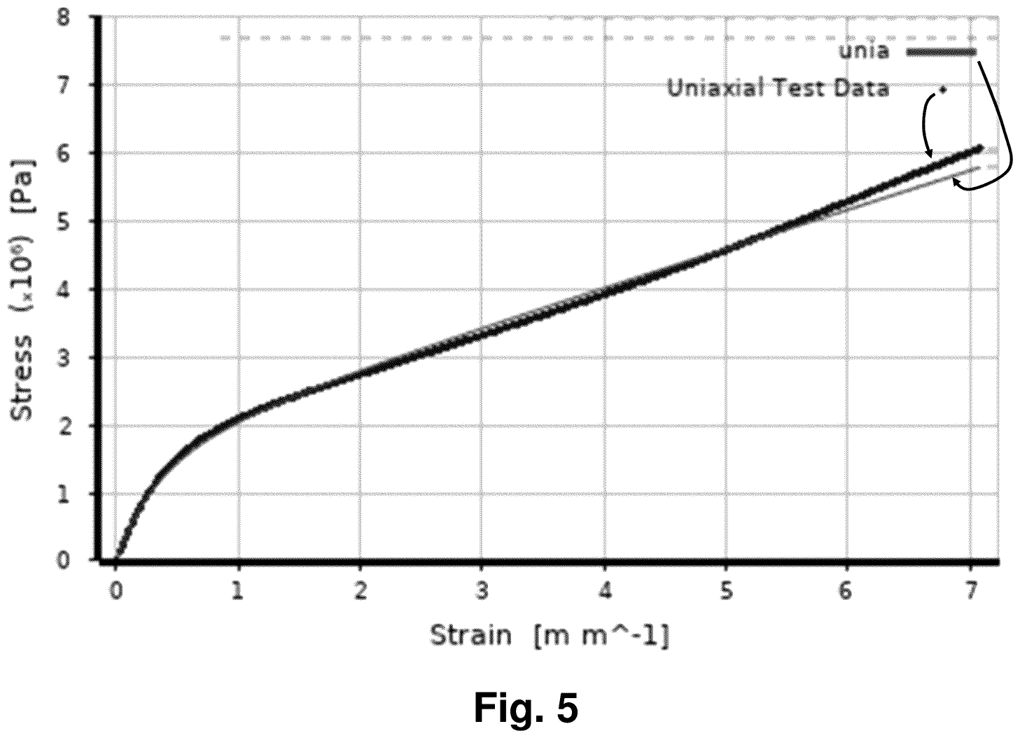

The resulting data points collected from the experiments were combined and an average value of the stress-strain curve for the model was created. The material density of the Filaflex TPU was retrieved as per the datasheet of the material to be 1.07 g/cm³. The average of the four stress-strain graphs of the material were then inserted into the simulation software. The simulation software used for the study was ANSYS Workbench. The material's stress-strain characteristics were subsequently analyzed by employing a well-established hyper-elastic model, specifically the Mooney-Rivlin model, for deformation prediction. FIG. 5 visually represents the curve fitting process for the Mooney-Rivlin second order model, based on the experimental data.

The strain energy equation representing this model is expressed as Equation (1):

$$W = {C}_{10} ( {I}_{1} - 3 ) + {C}_{01} ( {I}_{2} - 3 ) + \frac{1}{{D}_{1}} {( J - 1 )}^{2} \qquad ( 1 )$$

Here, the parameters C₁₀ and C₀₁ material-specific constants. The first deviatoric strain invariant is I₁ and second deviatoric strain invariant is I₂ while the incompressibility parameter is indicated by D₁. The hyper-elastic material used was assumed to be incompressible, hence, the result from only applying a uniaxial test data set to the Mooney-Rivlin model results in a value of zero for the D₁ parameter. In the case of incompressible materials, the variable J represents the elastic deformation gradient, and it is constrained to one due to the incompressibility of such materials. Consequently, in the last segment of the equation, this term becomes zero. This mathematical adjustment reflects the characteristic of incompressible materials, where volumetric changes are limited, rendering this portion of the equation negligible in the computation of strain energy. The two-parameter incompressible Mooney-Rivlin material model is then employed to characterize the local behavior of the TPU hyper-elastic material. The parameters retrieved from the Mooney-Rivlin second order curve fit is displayed in Table 1 below.

TABLE 1
Hyper-elastic material properties

| Coefficient | Value | Unit |
|---|---|---|
| Material Constant C01 | 0.59641 | MPa |
| Material Constant C10 | 0.28548 | MPa |
| Incompressibility | 0 | MPa⁻¹ |
| Parameter D1 | | |
| Material Constant C01 | 0.59641 | MPa |
| Density | 1.07 | g/cm³ |

The VSSA-1 is based on a sinusoidal wave-bending actuator design. The actuator may have a hollow internal cavity with thin walls. For instance, the walls of the actuator were kept ˜1.2 mm thick. The sinusoidal wave pattern extends the actuator linearly when the internal cavity is pressurized. To ensure that the actuator bends when the chamber is pressurized, a thin beam is attached to the desired bending side which constricts the expansion of the actuator in that direction. The initiation of bending motion is accomplished by applying pneumatic pressure to the internal expansion chambers of the VSSA-1. The resultant pressurization causes the unfolding of folds in the expansion chamber, setting in motion an asymmetrical bending response. This distinct asymmetry is deliberately introduced through the incorporation of a constriction beam exclusively on one side of the actuator. The strategic placement of this layer contributes to the controlled and directional bending behavior, a crucial aspect in tailoring the actuator's mechanical response for specific applications. This non-limiting design choice may allow for precise manipulation of the bending characteristics, enhancing the versatility and adaptability of the pneumatic actuator in practical scenarios.

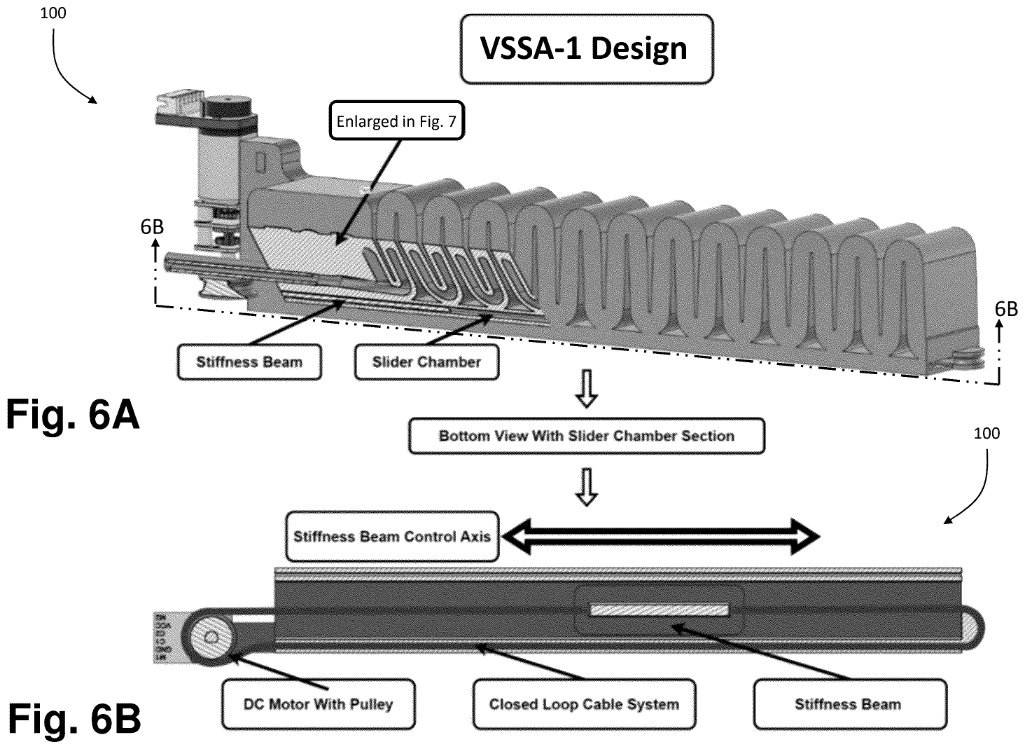

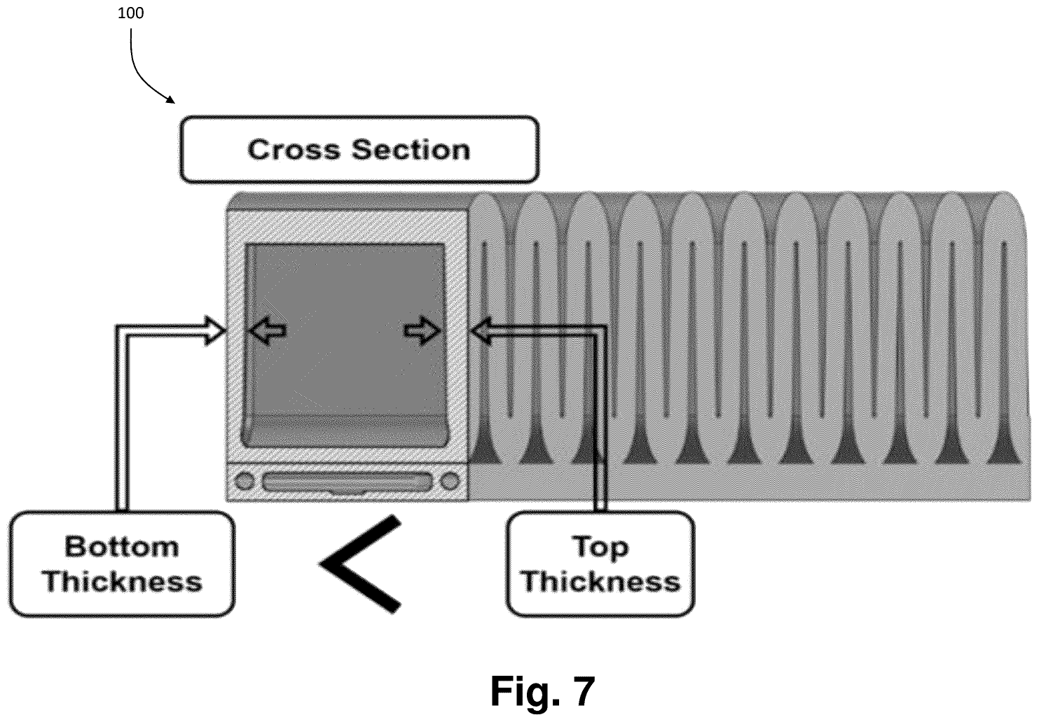

One feature of the VSSA-1 is that it may include a hollow slider chamber under the constriction beam of the actuator. The hollow chamber contains a rigid material, such as 3D printed PLA or Steel, stiffness beam which may be placed in any desired location under the actuator. The stiffness beam may be coupled to the hollow chamber through a slider contact joint under the pneumatically actuated sinusoidal wave-bending feature. The position of the beam is controlled through a closed-loop cable and pulley system, actuated from a small DC motor. The DC motor may include an encoder which is used to determine the position of the stiffness beam in the VSSA-1 based on the diameter of the pulley and the encoder value. The DC motor may be used as a low-power actuator that may quickly modify the position of the stiffness beam in the slider chamber which enables reconfigurable regions of varying stiffness within the actuator. Next to the slider chamber, another small tube feature may be present in the design that guides the cable back to the pulley on the actuator. The tube feature enables the cable-pulley to be a closed-loop system. The cable pulley system is attached in the same plane as the constriction beam on the actuator, as shown in FIG. 6.

Additionally, the fabrication process of the VSSA-1 was also considered during the design phase. The Fused Deposition Modeling (FDM) additive manufacturing technology used to fabricate the design operates in a layer-by-layer nature. The thickness of the top surface during the printing process is kept to ˜0.4 mm thicker than the thickness of the bottom (standard 1.2 mm thick). This ensures a proper application of the top 3D printed layers as the first 2 top layers act as a mesh on which the remaining top layers are supported where there may be no internal support structures in the geometry of the design.

FIG. 6A depicts a VSSA-1 configuration actuator with a partial cross section showing a closed-loop stiffness beam actuator while FIG. 6B shows a cross-sectional bottom view of the lower portion of the VSSA-1 actuator system depicted in FIG. 6A taken along line 6B-6B depicting details of a closed-loop stiffness beam actuation according to embodiments of the present disclosure.

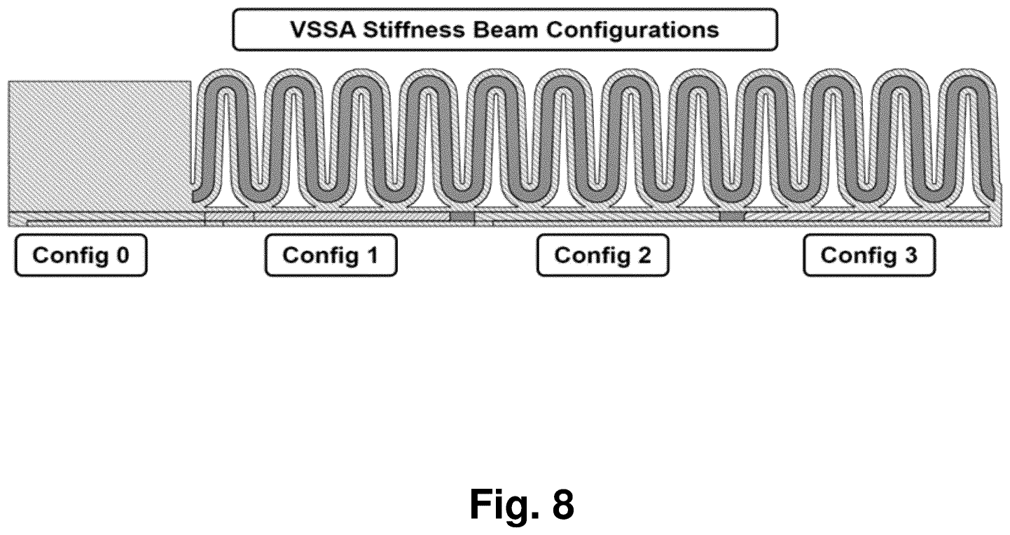

FIG. 7 is an enlarged view of the cross-sectional portion of FIG. 6A denoted with “Enlarged in FIG. 7” further depicting wall thickness differences between top and bottom surfaces.

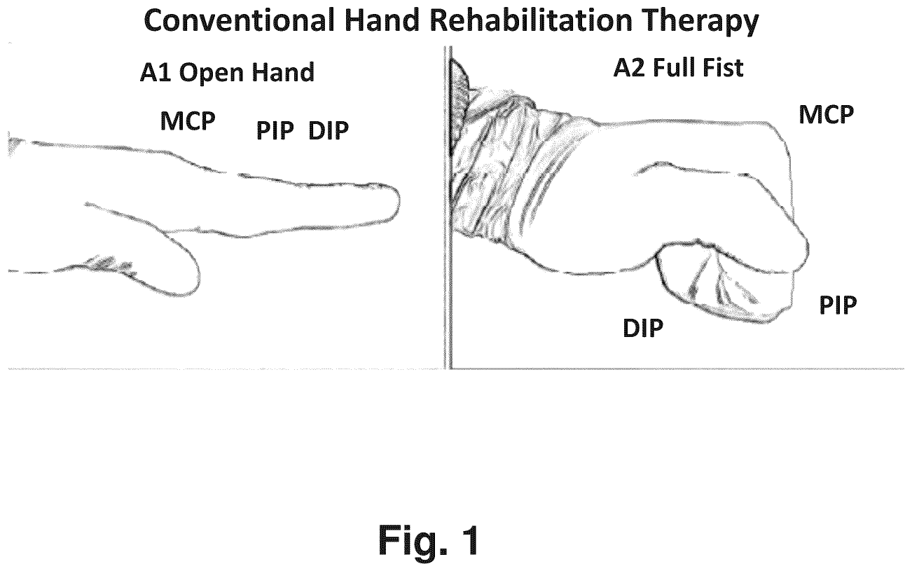

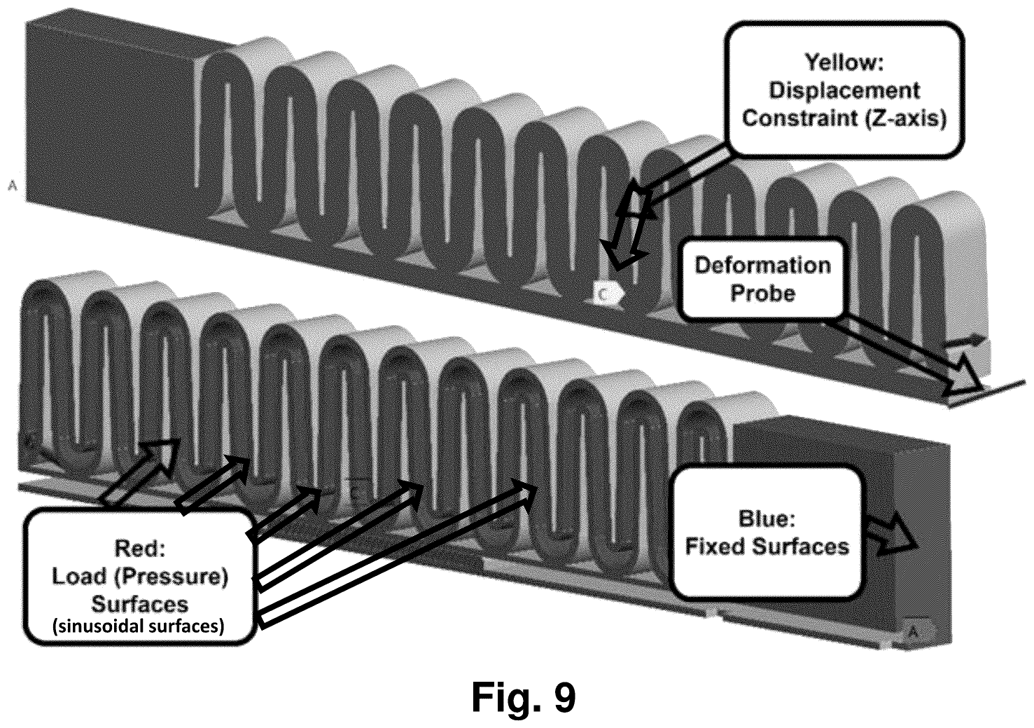

Testing the performance of the capabilities of the VSSA-1 required a comparison between the experimental data against Finite Element Analysis (FEA) simulations. A mathematical model of the pneumatic soft actuator is a complex item to produce, therefore, FEA simulations are used for validating the experimental data of the performance of the design. In this section, the focus is on the formulation and development of a comprehensive finite element model. The goal was to create a sophisticated computational tool capable of accurately predicting the mechanical behavior and, more specifically, the bending performance of the pneumatic actuator. This non-limiting description entails a detailed exploration of the underlying simulation parameters involved in capturing the intricate dynamics of the actuator under varying conditions. The significance of such a model lies in its potential to provide valuable insights into the actuator's response to pneumatic pressurization, enabling a deeper understanding of its mechanical output. The developed finite element model serves as a valuable analytical tool for researchers and engineers seeking to optimize and fine-tune the design parameters of pneumatic actuators for enhanced bending performance. The simulations and experiments were performed on four different configurations of the VSSA-1. The initial configuration (Config 0) placed the stiffness beam out of the deforming section of the VSSA-1. The next 3 configurations placed the stiffness beam in the slider chamber such that a third of the deformation section of the VSSA-1 was constricted successively for each configuration, as shown in FIG. 8. The stiffness beam position for each configuration between 1 and 3 is selected as they roughly correspond with the joint-blocking orthosis alternative rehabilitation therapies, as shown in FIG. 1.

The simulation of the VSSA-1 design was performed using FEA Static Structure Analysis in the Ansys Workbench. Ansys provides a powerful platform for conducting complex simulations of hyper-elastic material with a high degree of control over the simulation parameters. To enable a higher chance of convergence in the simulations, the VSSA-1 design was simplified for the simulations. The internal chamfers and differences in wall thickness were removed as those items assisted in the manufacturing process of FDM 3D printing only. The tube features used for guiding the control cable of the stiffness beam were also removed as they were not used during the simulations.

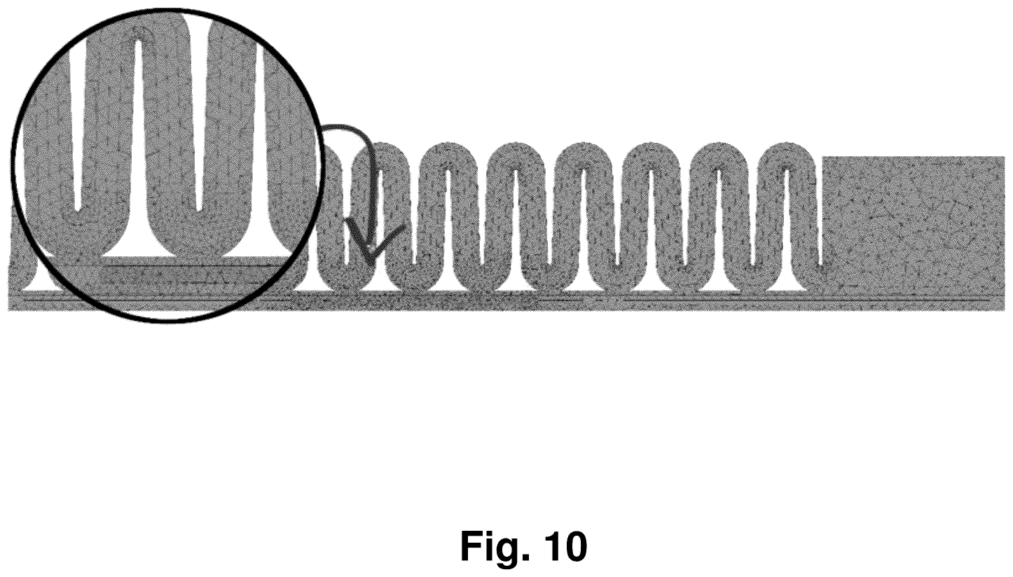

The material model of the hyper-elastic material was added to the simulation engineering data with the Mooney-Rivlin model. Specific model geometry was selected into named selections for the model to make contact selections easier. The geometry contacts were then enabled between all surfaces that were predicted to come in contact. The contacts were set as “Frictionless” contacts between all surfaces of the VSSA-1 model. Additionally, in order to hold the position of the stiffness beam at a constant location within the slider chamber, a small, extruded surface on the stiffness beam was attached to the slider chamber using the “Bonded” contact. The deforming sections of the VSSA-1 were set as fixed surfaces. The sections were set as grounded supports and were used as reference points in comparison to the remaining deforming surfaces. The surfaces of the internal chambers of the VSSA-1 were selected to exert a constant pressure perpendicular to the internal surfaces with a ramped pressure from 0 to 23 kPa. Additionally, the side surfaces of the VSSA-1 were applied with a displacement constraint which allowed the simulation to only deform in two degrees of freedom (DoF). The constraint was added to assist the convergence of the solution and assisted in the initial deformation phase of the simulations of the VSSA-1. FIG. 9 shows the simulation setup of the VSSA-1.

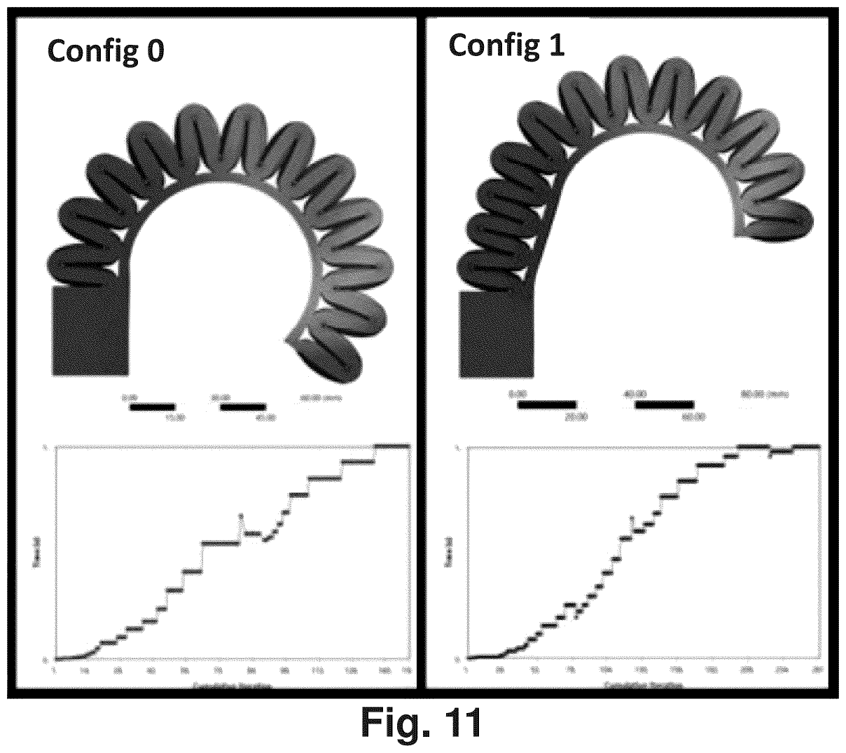

The expected outcome of the simulation was non-linear as the properties of the hyper-elastic material follow the Mooney-Rivlin second order model. The mesh settings were set to non-linear mechanical mesh with quadratic elements. The average size of the mesh elements throughout the VSSA-1 model was set to 1.5 mm. Due to the high bending contact nature of the stiffness beam and the sliding chamber, an increased mesh density was required in the slider chamber region containing the stiffness beam to achieve proper convergence of the solution. The contact sizing feature in the Ansys mesh controls was used to increase the mesh density in the stiffness region by reducing the mesh element size to 0.7 mm. The VSSA-1 design was not set to such a high mesh density to reduce computational load during the simulations. FIG. 10 illustrates the increased mesh density feature in more detail.

Lastly, the analysis settings for the simulations were configured. The simulation was set to a one-second time with the initial step starting at 0.001 s. The small initial step size was set to allow the solution to reach convergence more gradually as it ramped the pressure to the final value. The minimum step size was set to 0.0005 s which assisted the simulation in overcoming challenges during contact change phases in the VSSA-1 and the maximum step size was kept at the default setting of 1 s. Additionally, the solver was configured to an iterative solver for the simulation and large deflections were enabled.

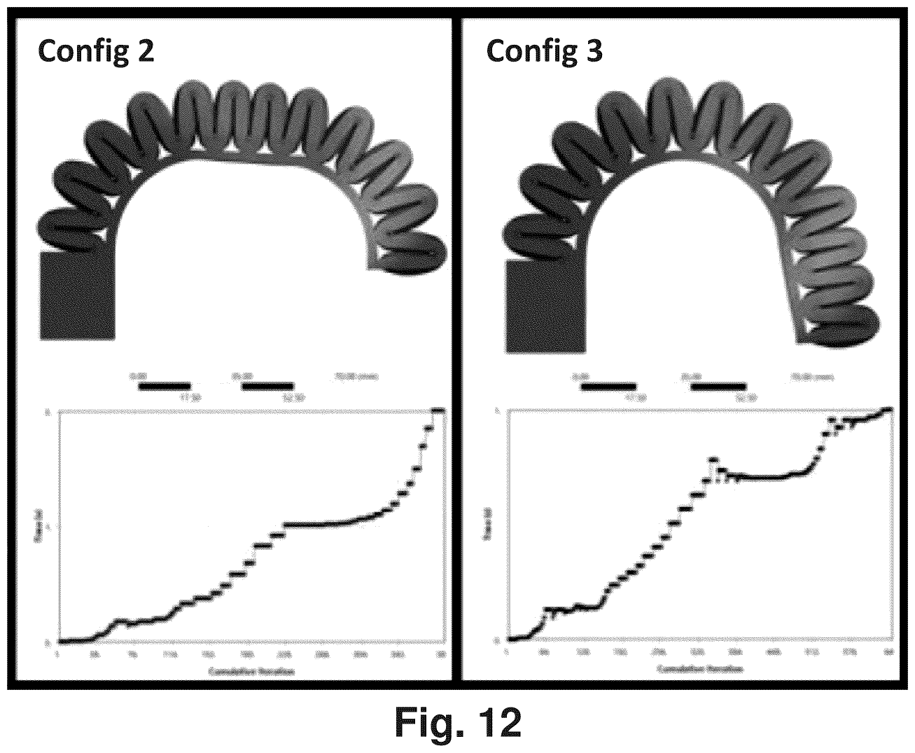

Once all the simulation settings were configured, the simulation was run using a total deformation analysis with two deformation probes attached to the end tip of the VSSA-1, as shown in FIG. 9 The deformation in the X and Y axes was measured with respect to the original undeformed model of the simulation. The results in FIGS. 11 and 12 show the simulations conducted in Ansys for each of the configurations with convergence time plots.

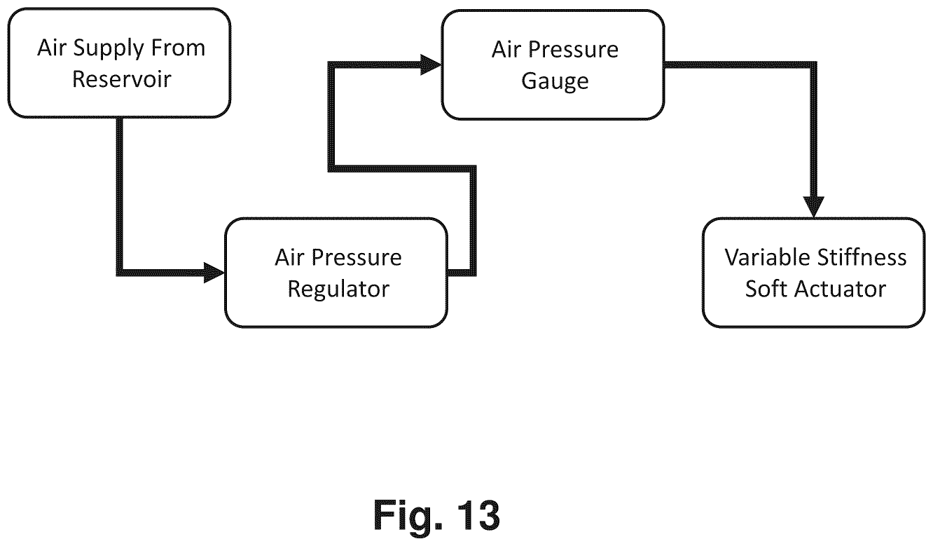

The experiments were conducted using the same approach as the FEA simulations. The VSSA-1 was fixed to a board from the non-deforming surfaces at the base of the actuator. Air was supplied through a high-pressure and high-flow source with a regulator at the source to limit the amount of airflow and pressure in the VSSA-1. The air pressure was also monitored using a high-accuracy pressure sensor with a measurement range of 0 to 400 kPa. After flowing through the pressure sensor, the air was channeled through a polyurethane tube to the actuator. The experimental setup described follows the diagram as shown in FIG. 13.

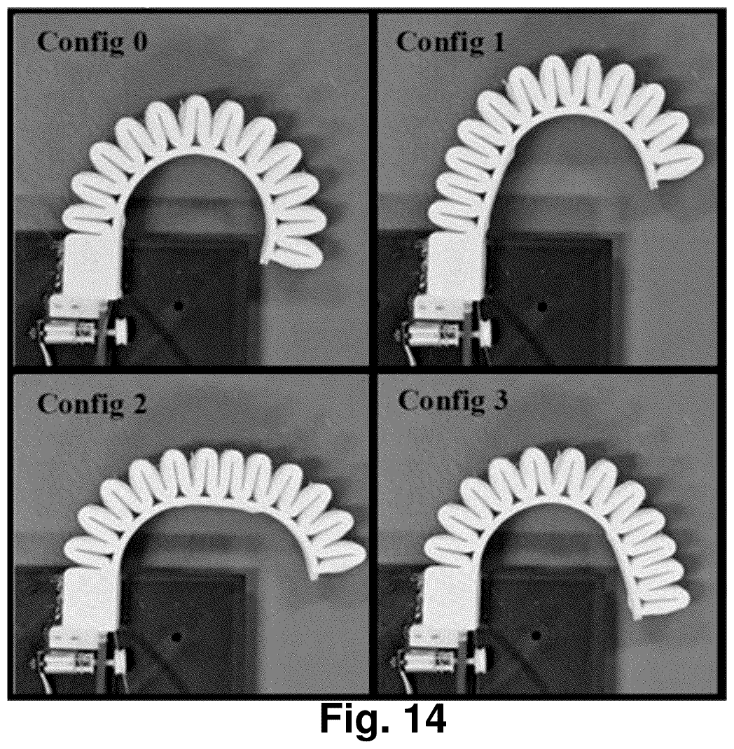

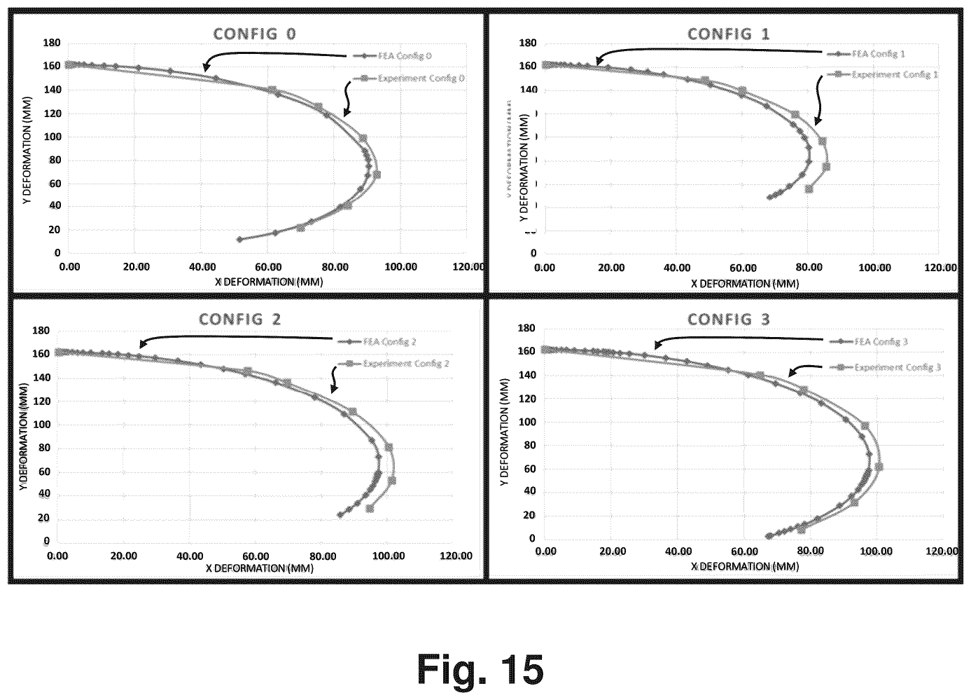

FIG. 14 depicts the variable stiffness actuator system VSSA-1 in final deformations achieved by the robotic system in each simulated configuration and FIG. 15 depicts a series of line graphs illustrating an experimental and FEA simulation tip deformation comparison for each configuration according to embodiments of the present disclosure.

The small DC motor on the VSSA-1 was used to control the position of the stiffness beam in the slider chamber. The four different configurations were individually set for each experiment. The pressure in the VSSA-1 was ramped using a valve on the regulator from 0 to 120 kPA as measured on the pressure gauge. The cause of the pressure difference between the FEA simulations and experiments of the VSSA-1 is discussed further in the comparison section below. The pressure was ramped for each configuration from 0 to 30, 40, 60, 80, 100, and 120 kPa consecutively. The deformation of the VSSA-1 in each configuration was observed using a camera mounted at a fixed position above the deforming VSSA-1. The camera was used to capture the deformation of the VSSA-1 at each pressure point mentioned above between 0 and 120 kPa. The figure below shows the final deformation achieved by the VSSA-1 in each configuration.

Upon completion of the experiments, the VSSA-1 tip deformation trajectory of the FEA simulations was compared against the experimental data. The tip deformation was noted as per the position of the probe in FIG. 9 and was used in both scenarios. The data was directly retrieved from the Ansys results for the FEA simulation and raw displacement measurements were used for the experimental data. The images for the experiment were scaled appropriately and used to measure the deformation of the VSSA-1. The deformation measurements were taken from the bottom right corner of the VSSA-1 to the actuator tip, which is the same point as the probe in the simulation.

The analysis of the tip deformation plots of the VSSA-1 show that despite the difference in required pressure, both the FEA simulations and experiments follow a very similar trajectory with slight variations in the X-axis deformation. Table 2 below displays a comparison of the X-axis deformation between the two sets of data for each configuration, showcasing the maximum difference in the deformation of the VSSA-1 being 5.37 mm on configuration 1 with a percentage difference of only 6.49%. The Y-axis deformation was not compared as the difference in pressure required for the deformation was not modeled. Due to the lack of a reliable model for the air leak, the plots in all configurations show that the overall deformation in the FEA simulations was greater than in the experiments on the Y-axis.

TABLE 2

| | FEA vs Experiment X-Axis Deformation | | | |
|---|---|---|---|---|
| | | | Max | |
| VSSA | FEA Max | Experiment | Difference | % |
| Config | (mm) | Max (mm) | (mm) | Difference |
| Config 0 | 90.34 | 92.66 | 2.32 | 2.50 |
| Config 1 | 80.05 | 85.42 | 5.37 | 6.49 |
| Config 2 | 97.26 | 101.26 | 4.00 | 4.03 |
| Config 3 | 97.36 | 100.33 | 2.98 | 3.00 |

Manufacturing errors caused by the soft hyper-elastic material during the 3D printing process caused defects in the parameters of the expansion chambers of the actuator. The defects in the expansion chamber were the primary source of the air leaks. The air leaks across the VSSA-1 expansion chambers were non-linear. Due to the irregularities in the defects present in the parameters of the expansion chambers in the VSSA-1, the air leaks vary across different configurations as the configuration changes (moving the stiffness beam), the expansion chambers in the stiff region deform less than those in the flexible region. Future iterations of the VSSA-1 fabrication will use more robust manufacturing processes to ensure minimum air leaks with additional improvements in the design such as increasing wall thickness or using materials with more predictable printing characteristics.

The existing prototype lacks a feedback system, notably the absence of sensing elements. It is contemplated that the integration of a feedback system is deemed beneficial for achieving precision in control. To enhance the device's responsiveness to external stimuli, the incorporation of diverse sensors may become imperative. These sensors include but are not limited to, pressure sensors that measure the internal pressure of the expansion chambers, a soft elastic angle sensor that may be used in conjunction with the position of the stiffness beam to determine the final position of the actuator, and/or a force sensor to determine the power of the actuator. This augmentation aims to fortify the system's robustness by providing real-time data on various parameters, enabling more accurate control and adaptability to dynamic environmental conditions.

Advantageously, the system of the present disclosure is capable of selectively modifying the stiffness of regions above desired joints, thus enabling a variety of different motions from a simple actuation source and a smaller actuator used for determining the stiffness of regions within the actuator. The proposed design was tested with four different configurations in which stiffness regions within the actuator are adjusted. The design was initially tested in a Finite Element Analysis simulation using hyper-elastic non-linear material settings which were used to determine the expected behavior of the actuator in different configurations as the pressure was increased. The simulation results were then compared to experimental results following the same configuration setup. Though the actuation pressure required was vastly different between the simulations and experiments due to air leaks, the system of the present disclosure desirably demonstrated an acceptable replication of the FEA simulations with only minor differences in the tip trajectory of the actuator.

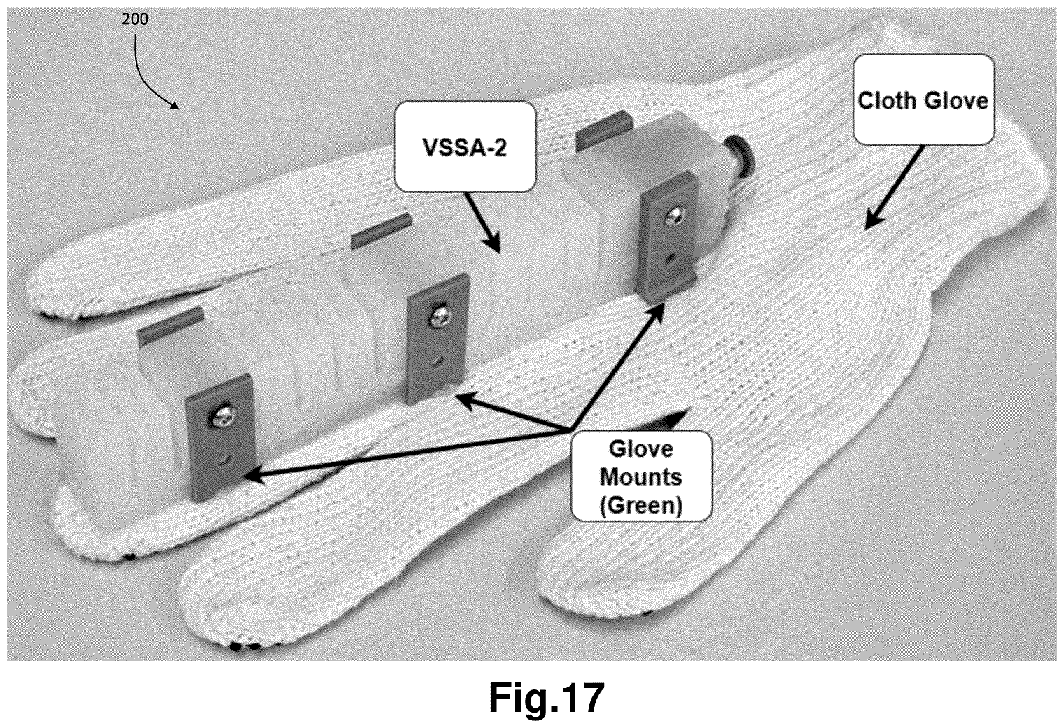

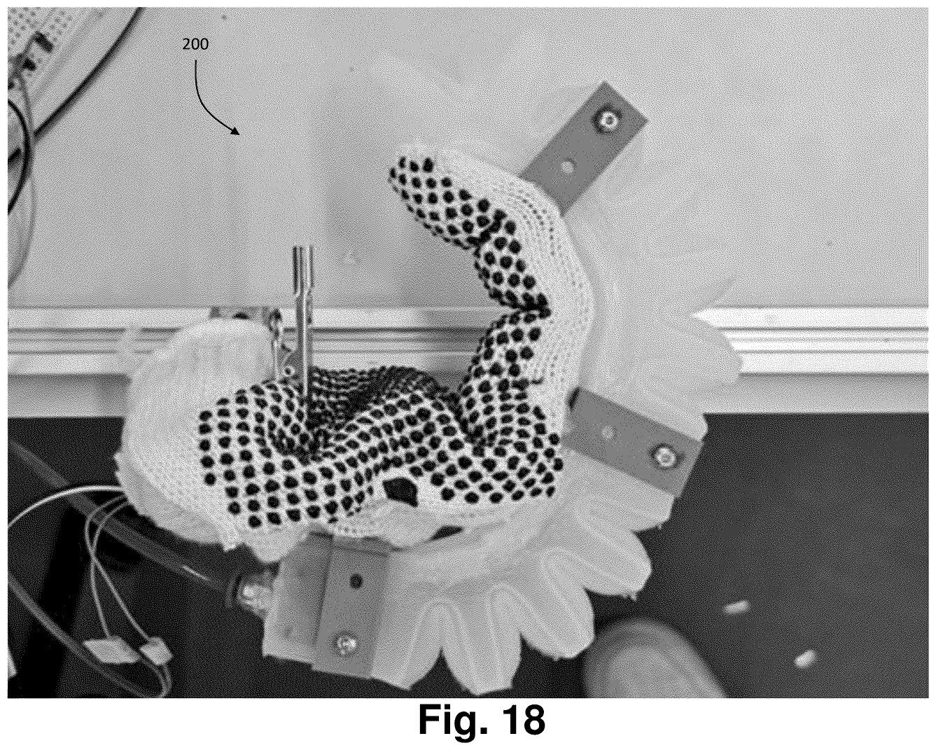

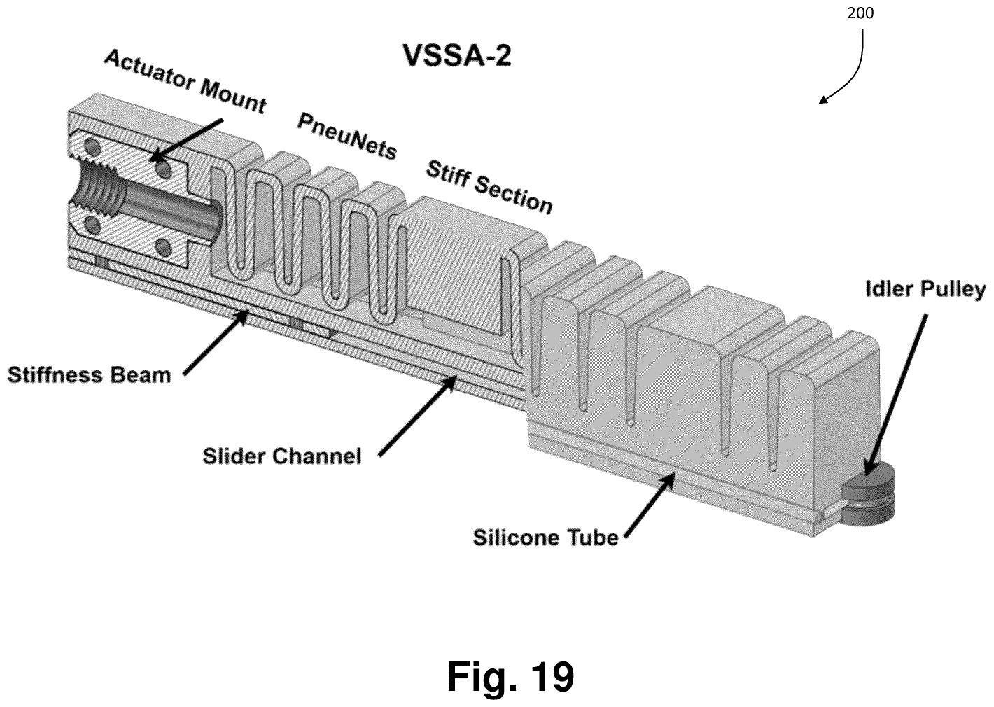

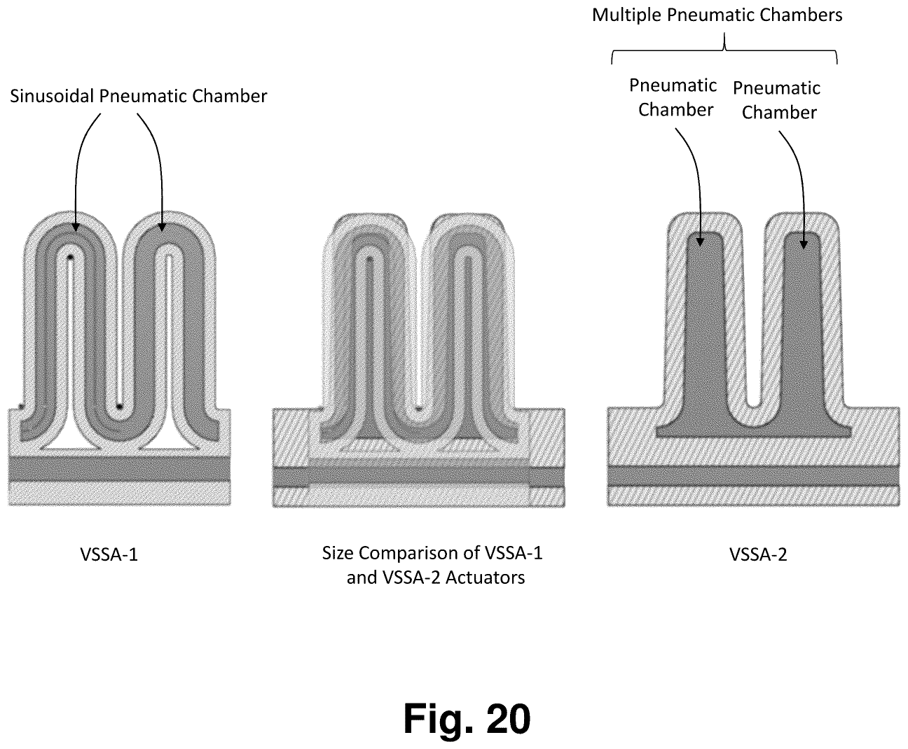

Depicted in FIGS. 17-21 are alternate configurations of a variable stiffness actuator 200 according to further embodiments of the present disclosure. These alternate configurations (also referred to as VSSA redesigns or VSSA-2 configurations) were developed as improvements to the VSSA-1 variable stiffness actuator embodiments disclosed earlier in this document. FIGS. 17 and 18 depict a glove with an actuator over a single finger, while other embodiments include multiple actuators, wherein each of the actuators are positioned over a different digit (e.g., finger). The VSSA-2 embodiments include a corrugated upper portion that externally resembles the VSSA-1 embodiments, and can include both stiff sections and bending sections with the bending sections being located in regions adjacent the joints of the hand (see, e.g., FIG. 19). VSSA-2 embodiments can also include alternate pneumatic bending actuators that instead of a sinusoidal pneumatic chamber (see, e.g., FIG. 20) utilize multiple pneumatic chambers that can be connected to one another. In some VSSA-2 embodiments, the multiple pneumatic chambers in the actuating sections resemble PneuNet actuators, which is used to describe the bending sections in FIG. 19. The actuation motion sections and stiffer sections are arranged to optimize the actuator fit over a finger. The VSSA-2 actuators are soft robotic actuation systems consisting of interconnected air chambers that create bending motion when pressurized. Their design (that can include inextensible layers and chamber variations) enables flexible movements and can have applications in devices like rehabilitation gloves and soft exoskeletons. The VSSA-2 arrangements with spaced apart “PneuNet” actuation sections provides improved ergonomics by bending only at the finger joints and limiting unnecessary strain on the fingers.

The VSSA-2 redesign started with the development and testing of a single PneuNet-type actuation section. The parameters for this section were based on a single period of the sinusoidal design of the previous VSSA-1 as shown in FIG. 20. Features such as draft angles were also added to the VSSA-2 embodiments to aid in Design For Manufacturing (DFM). A minimum of two PneuNet-type actuation sections were used to create a single PneuNet-type contact region (PCR). The contact region pushes the two PneuNet-type actuators against each other, which in turn causes the bending actuation motion.

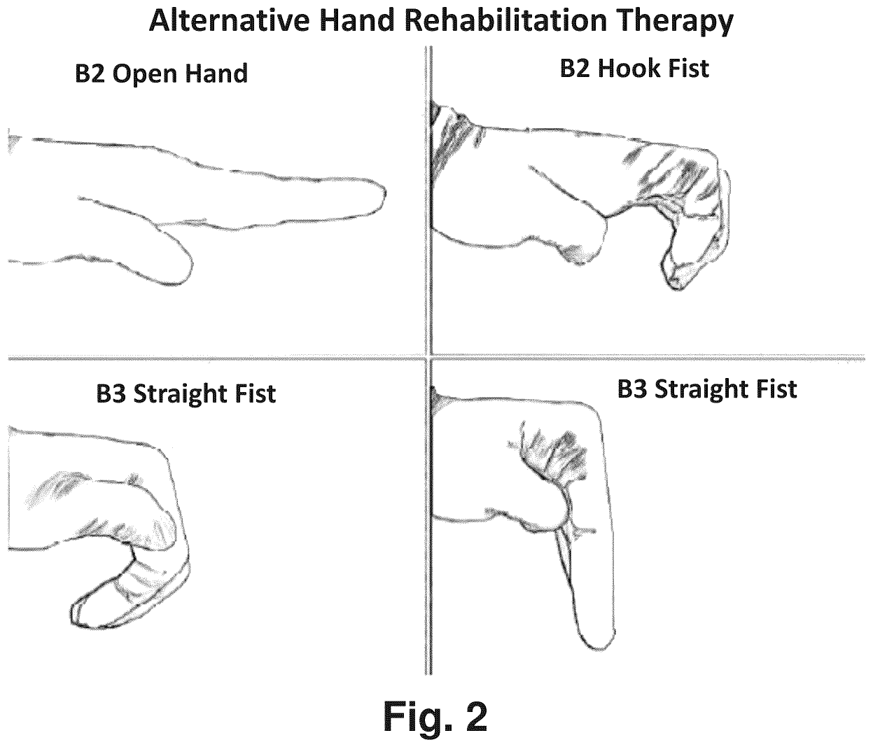

The redesigned VSSA-2 as shown in FIG. 19 removed the previous sinusoidal motion and embraced the PneuNet-type design approach. The new VSSA-2 also added the PneuNet-type actuation sections only above the finger joints to facilitate better ergonomics with increased contact between the finger and actuator. Fitting within the same geometry, four PCRs were added above the MCP and PIP joints, and two PCRs were added above the DIP joint of the VSSA-2. See, FIG. 1 for locations of the MCP, PIP and DIP joints. Using the B3 Straight first from FIG. 2 as a default actuation configuration (no joint-blocking), the desired joint angles for the MCP and PIP finger joints were 90 degrees. The DIP joint was set to a 45-degree actuation angle, even though MCP, PIP and DIP joints typically bend at 90 degrees. Size limitations from the actuator and mounting hardware, like gloves, restricted the DIP joint's motion.

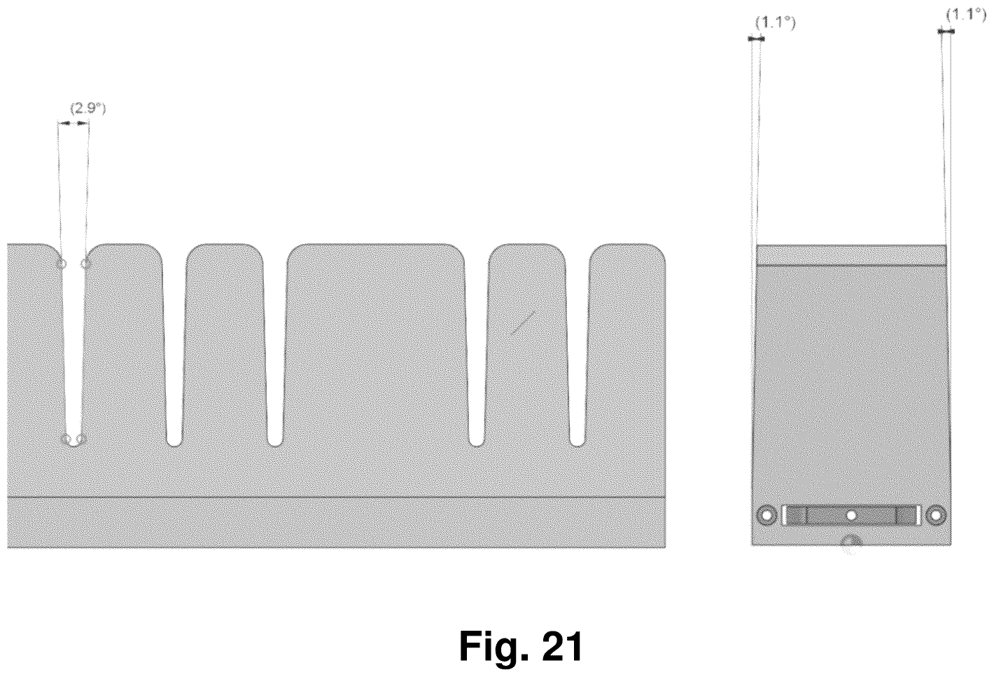

FIG. 21 includes depictions of a VSSA-2 actuator from the side (left depiction) and from an end (right depiction).

Having a requirement of 90 degrees bend on the MCP and PIP joints with 4 PCRs above them, the required PCR deformation angle was 22.5 degrees. The PneuNet-type actuators were tested using an FEA method with a pressure sweep on the internal walls from 0 to 15 kPa in one second. The model demonstrated that a PneuNet-type actuator was able to bend at an angle of 22.5 at 13.5 kPa.

Embodiments of the VSSA-2 design can use stiff materials made from plastic (PLA/ABS) or metal for the stiffness beam, actuator mount and idler pulley. The actuator mount can include mounting holes to allow the actuator to be attached to external hardware. The actuator mount can be threaded to attach a male pneumatic fitting connector. The connector can allow tubes (e.g., PolyTetraFluoroEthylene (PTFE) Teflon tubes) to be connected to the actuator, creating a secure and airtight fit. The tube carries pneumatic pressure from an air supply to the actuator. The adjustable length of the Teflon tube can provide flexibility in the system as the power source can be placed away from the sink. The idler pulley and actuator mount can be glued to the actuator using, e.g., a silicon bonding epoxy such as Smooth-On Sil_Poxy (Sil-Poxy™ product information, n.d.). Furthermore, the cable channels can be created using soft silicon tubing. In at least some embodiments, the silicon tubes are placed next to the slider chamber. The cable channels allow the position of the stiffness beam to be controlled using a cable pulley mechanism as described in the original VSSA-1 design.

The fabrication process of the VSSA-2 can use a molding manufacturing technique. The Design For Manufacturing (DFM) methods were applied to the VSSA-2 design to ensure defects were reduced during the fabrication process. Chamfers can be added to the design to remove sharp corners (corner radius >0.5 mm). Draft angles of approximately 1 degree (against vertical) can be added to the walls of the PneuNet-type actuators. See, e.g., FIG. 21. The DFM features facilitated component release from the mold by reducing pinching points and reducing friction during demolding. FIG. 21 shows the optional DFM features on the VSSA-2 design.

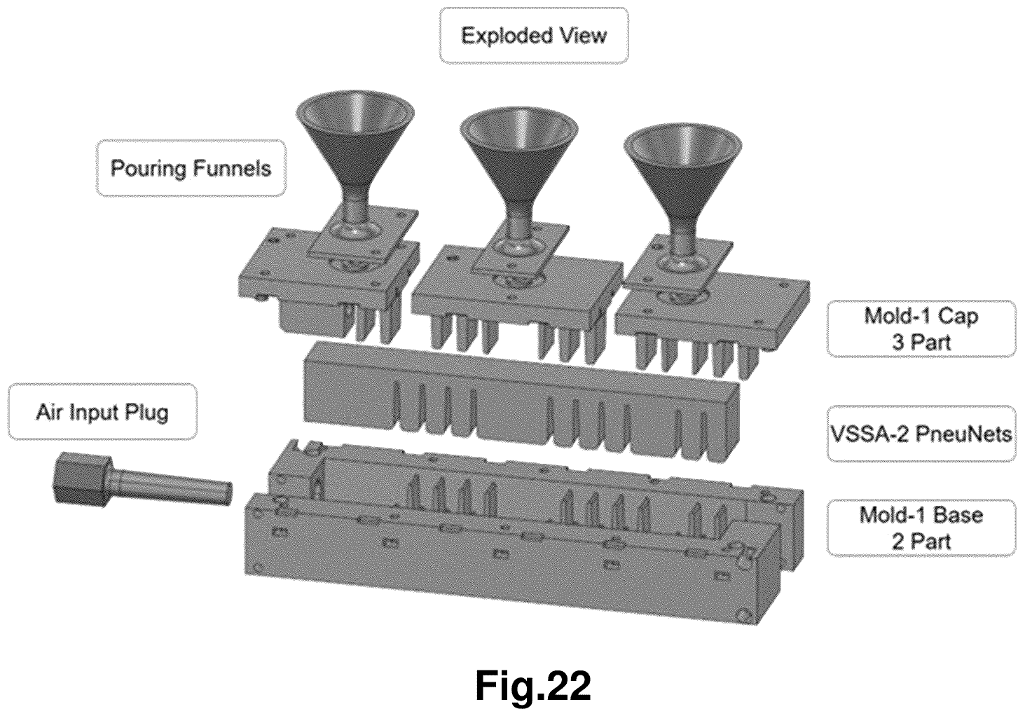

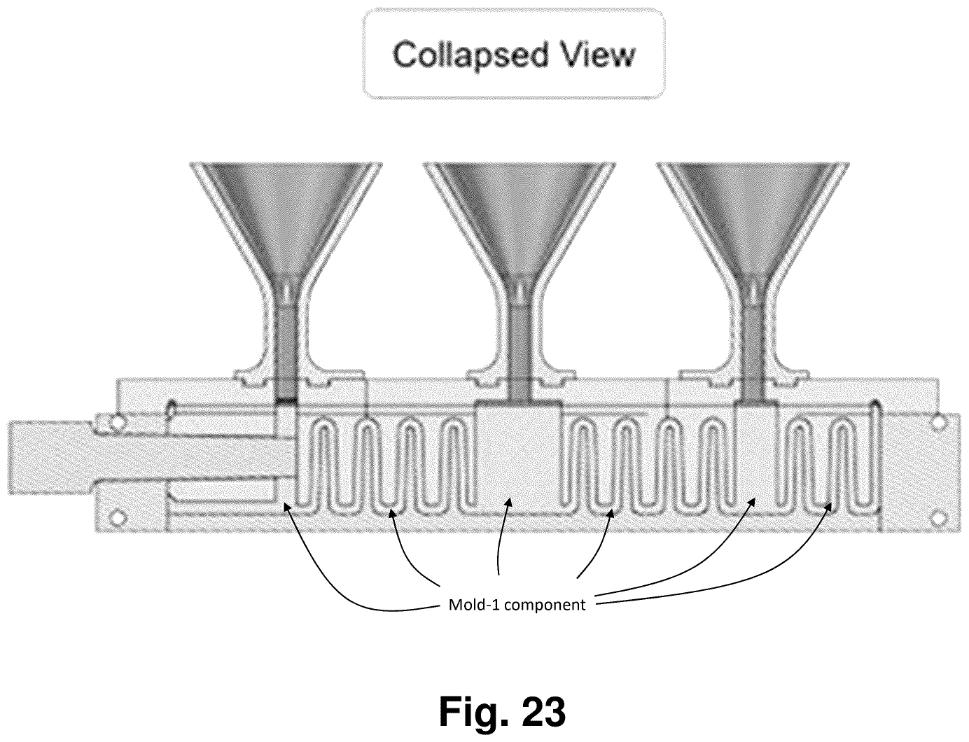

Turning to FIGS. 22 and 23, the VSSA-2 embodiments can be fabricated using a two-part process and custom-designed molds. The molds can be designed as a negative shape of the VSSA-2, which was removed from a block of material. The molds can be 3D printed using, e.g., PLA plastic, which can allow rapid prototyping, allowing quick fixes and changes until desired shapes are reached. The VSSA-2 can be fabricated in two parts as the internal cavities are not able to be generated using a molding process. The first part of the fabrication process can use a Mold-1, which can be used to make the PneuNet-type actuators of the VSSA-2. Mold-1 consists of nine (9) components that combine to form the mold. Mold-1 includes a base divided into two parts, a cap divided into 3 parts, 3 pouring funnels and a plug for the air input. Dividing the mold into base and cap into smaller sections improves the ejection process of the component from the mold as less force is needed to remove them. FIG. 22 shows an exploded view and FIG. 23 shows a combined (“collapsed”) view of Mold-1. The VSSA-2 produced from Mold-1 includes PneuNet-type actuators that are open from the bottom to allow the cap to be removed. The indicated section in the collapsed view of FIG. 23 shows the component produced by Mold-1.

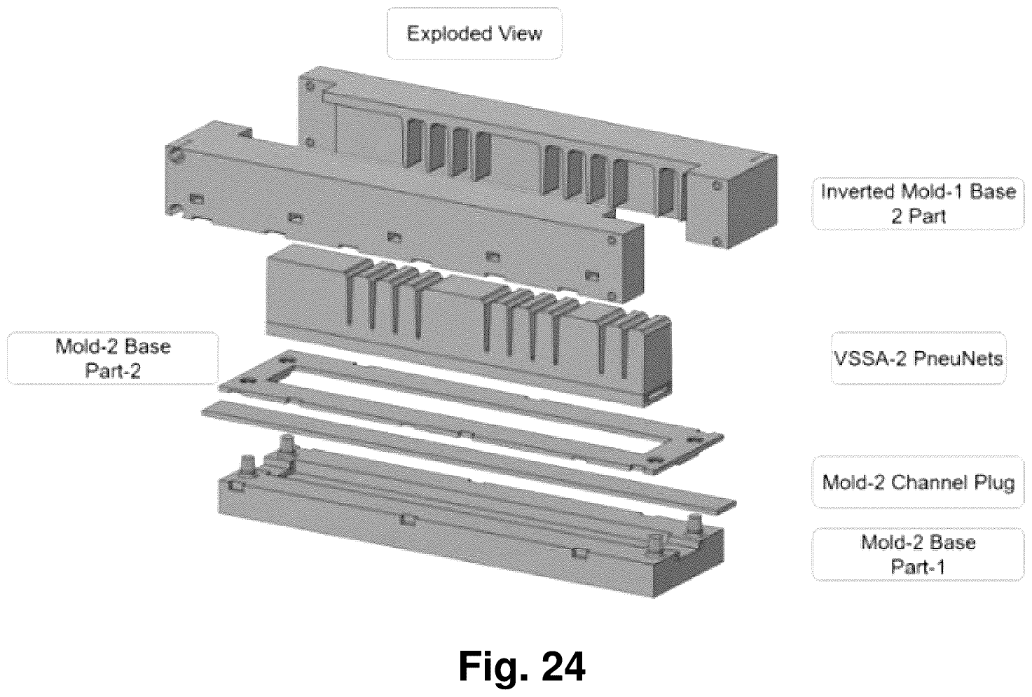

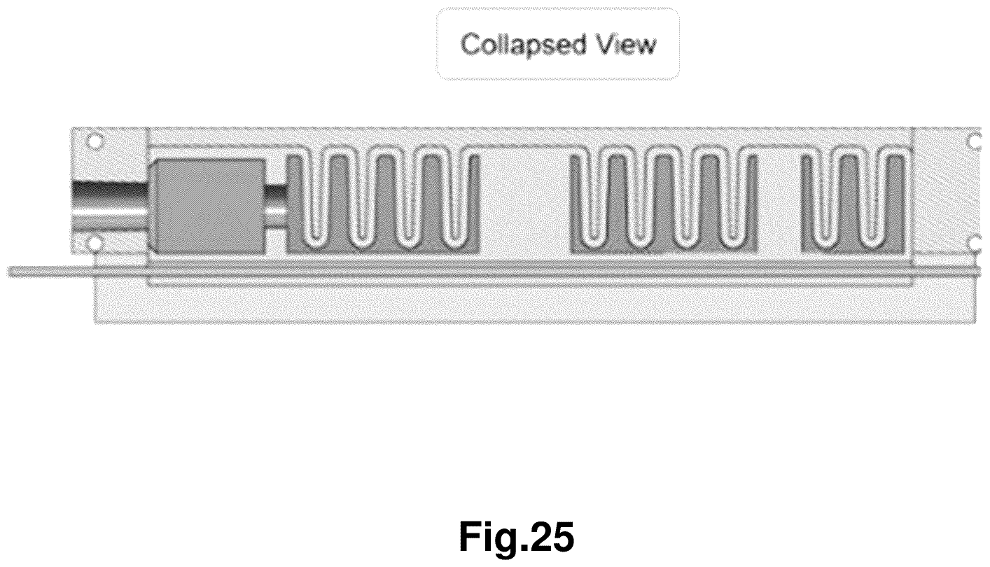

After the partial VSSA-2 component has been fabricated in the Mold-1, the part may be ejected. The air input plug may be pulled out, the three Mold-1 caps may be gently lifted and removed along with the pouring funnels. Any excess material in the pouring funnels may also be removed by cutting it from the main body of the fabricated part. The partial VSSA-2 fabricated part is kept in the Mold-1 base, flipped over, and inserted into the Mold-2 base. The Mold-2 is the second part of the process in the fabrication of the VSSA-2. Mold-2 is responsible for closing the PneuNet-type actuators to create an airtight internal cavity. The silicone tubes and slider channel are also added in Mold-2. The silicone tubes are held in tension next to the Mold-2 plug. The silicone mixture is poured into the cavity until it reaches the top and the previously cured partial VSSA-2 held in Mold-1 base is placed on top. Allowing the new section to be cured with the previously fabricated part in contact creates a homogenous material. This method helps ensure that the part is made airtight and has consistent material properties throughout the part. After curing, the part is ejected from the mold, and the plug is detached to create the slider channel. FIGS. 24 and 25 show an exploded and combined (“collapsed”) view of Mold-2.

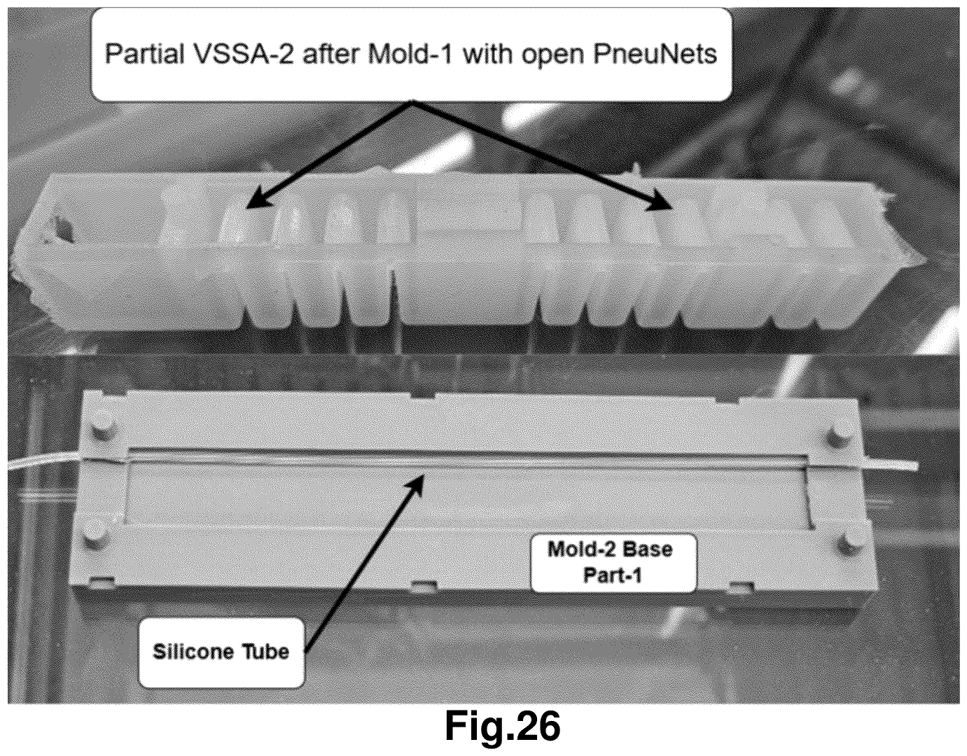

The fabrication process can include preparing the molds and the material. The molds can be sprayed with mold-release spray and left to dry for 30 minutes to an hour. The spray creates a thin film barrier between the 3D-printed mold and the silicone material to aid in part ejection once the silicone had cured. The silicone can be prepared by mixing two equal parts of the silicone material, which can be referred to as Part A and Part B. The mixture can be stirred for 3-5 minutes and then placed in a vacuum chamber to de-gas. De-gassing is a helpful stage in the silicone molding process as it removes air bubbles from the material. The lack of air bubbles creates a homogenous structure after curing, allowing for more predictable material behavior in the final product and reducing defects. Once the silicone mixture is de-gassed, it can be inserted into the mold cavities and allowed to set for 8 hours to cure. FIG. 26 shows the partial VSSA-2 ejected after curing from Mold-1 and the attachment of the silicone tube in Mold-2 before the silicone resin is poured in for the second molding process.

The experimental design aimed to validate the performance of the VSSA-2 by comparing FEA simulations and experimental data. A finite element model was used in analyzing key simulation parameters to capture the actuator's response under pneumatic pressurization. The model emphasized the actuator's bending behavior and mechanical output. The experimental and simulation analysis involved four configurations for the VSSA-2 with varying stiffness beam placements. The placement of the stiffness beam emphasized performing the alternative hand rehabilitation therapies as shown in FIG. 1. The four configurations were labeled from Configuration 0 to Configuration 3. The configurations were set align with joint-blocking orthoses rehabilitation methods as shown in FIG. 1.

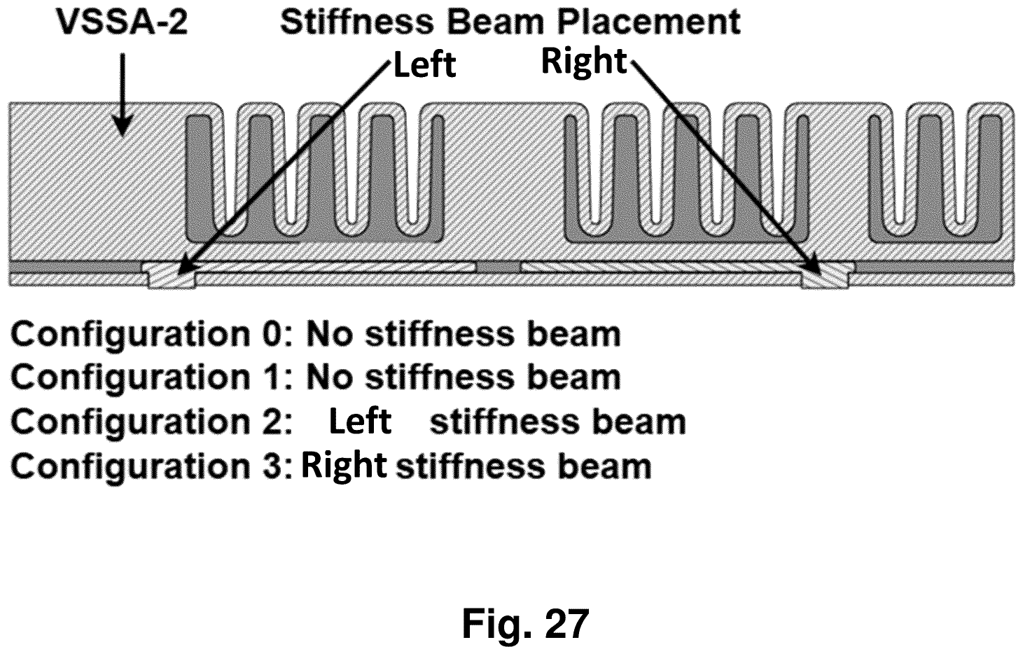

Configuration 0 was set to an open-hand position and used as a control value against which the other configurations were compared. Configuration 0 was the undeformed origin point for the other 3 configurations. Configuration 1 was set to perform the actuation with no joint blocking to allow all the joints to bend to form the straight fist. Configuration 2 was set to perform the actuation hook first by blocking the MCP joint with the placement of the stiffness beam above the corresponding finger joint. Finally, Configuration 3 was set to perform the table-top first by placing the stiffing beam above the PIP joint, consequently blocking it. FIG. 27 shows the placement of the stiffness beam in the VSSA-2 during the experiments

The deformation of the VSSA-2 tip was recorded as an actuation pressure was applied. Data points plotted on an x-y axis generated tip trajectory curves, which enabled a direct comparison of FEA and experimental results. Deformation, as a function of pressure was analyzed for each configuration with Configuration 0 as the baseline.

The experimental setup replicated the conditions modeled in the FEA simulations discussed earlier. The VSSA-2 was mounted to a smooth board using the actuator mount. The actuator was placed on its side with the PneuNet-type actuators dragging on the board. To mitigate the effects of gravity on the experiments, a thin film of dish soap was applied as a lubricant to the surface of the board. The lubricant allowed the actuator to slide freely during the experiment with minimal resistance. A high-flow air source, regulated to control airflow and pressure, supplied air through a polyurethane tube to the actuator. A pressure sensor with a 0-400 kPa range monitored internal pressure. A Camera was positioned above the VSSA-2 to capture the deformation of all the configurations. The collected data was analyzed to compare FEA and experimental deformation trajectories and evaluate the stiffness modification across configurations.

Additional experiments were conducted on the performance of the VSSA-2 by attaching the VSSA-2 to a glove configuration (see, e.g., FIGS. 17 and 18) to measure its performance in operating as a hand rehabilitation device. The VSSA-2 was mounted to a cloth glove using intermediate glove mounts that were connected to glove using an adhesive (e.g., Sil_Poxy glue). The VSSA-2 was directly connected (e.g., bolted) to the glove mounts, which securely attached the VSSA-2 actuator to the glove and ready to be used for rehabilitation as shown in FIG. 17.

Measuring the performance of the VSSA-2 included measurement of the VSSA-2 actuator tip force and comparisons were made to a commercially available hand rehabilitation device (CAHRD). A finger test stand was developed with three finger joints to simulate a human finger. The rehabilitation device was attached to the finger test stand to measure the performance of the actuation motion. While prior research on variable stiffness hand rehabilitative gloves measured only the tip forces of the actuator, the test data of the VSSA-2 was collected from the fingertip as well as the MCP and PIP joints. The data from the MCP and PIP finger joints in addition to the tip force provided feedback from the individual joints, creating a cohesive set of values that could better evaluate the performance of the rehabilitation device. Flexible force sensors were placed above the MCP and PIP joints from which the data were read as analog values in a microcontroller. The force sensors were used to record the force applied by the actuators on the MCP and PIP joints, causing them to bend when the actuator was powered.

The finger test stand was used to collect data from the VSSA-2 glove and the CAHRD in the Straight Fist, Hook first and Table Top first configurations shown in FIG. 1. One difference between the VSSA-2 and the CAHRD was the design of the actuation units. The VSSA-2 was designed based on individually bending actuators (e.g., PneuNet-type actuators) while the CAHRD devices were based on an extending bellows-actuator design. Bellows-actuators are formed by cylindrical structures with repeating folds on the cylinder's walls creating a series of crests and troughs. Unlike the bending actuators in the VSSA-2, the bellows-actuators expand in length when supplied with air. The CAHRD designs rely on the increase in length of the bellows-actuators above the finger joints to create moment on the joint, causing it to bend.

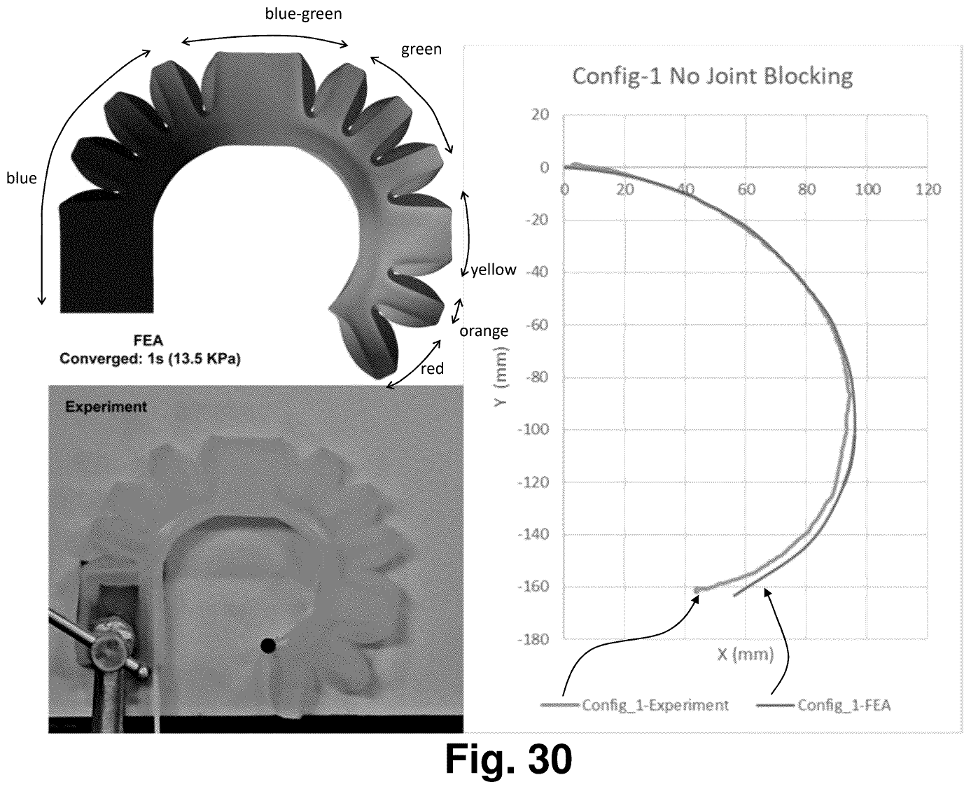

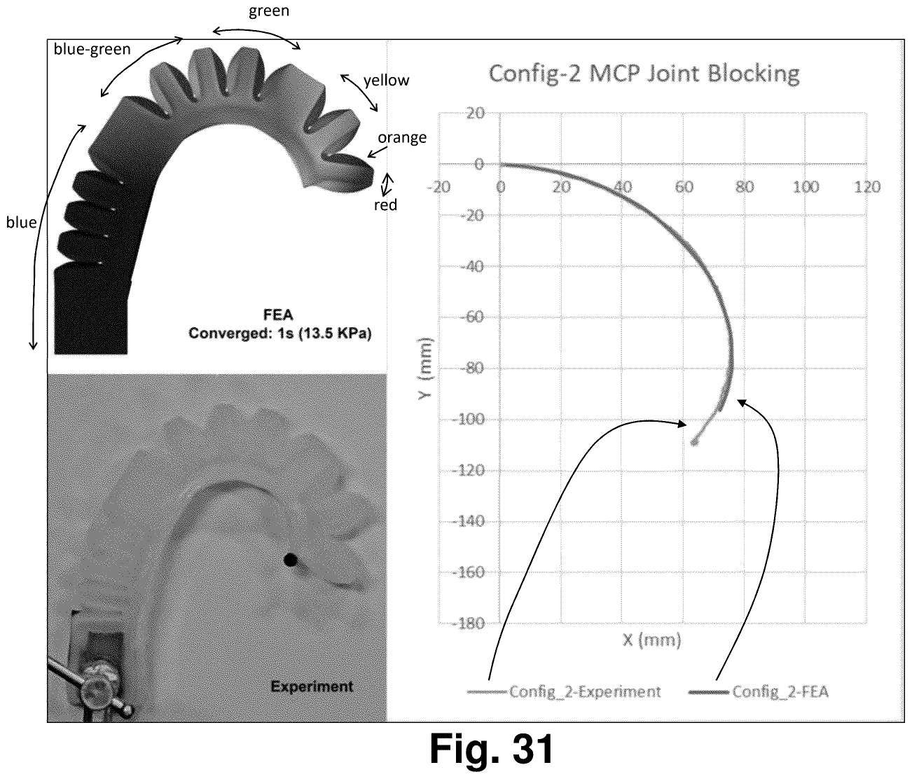

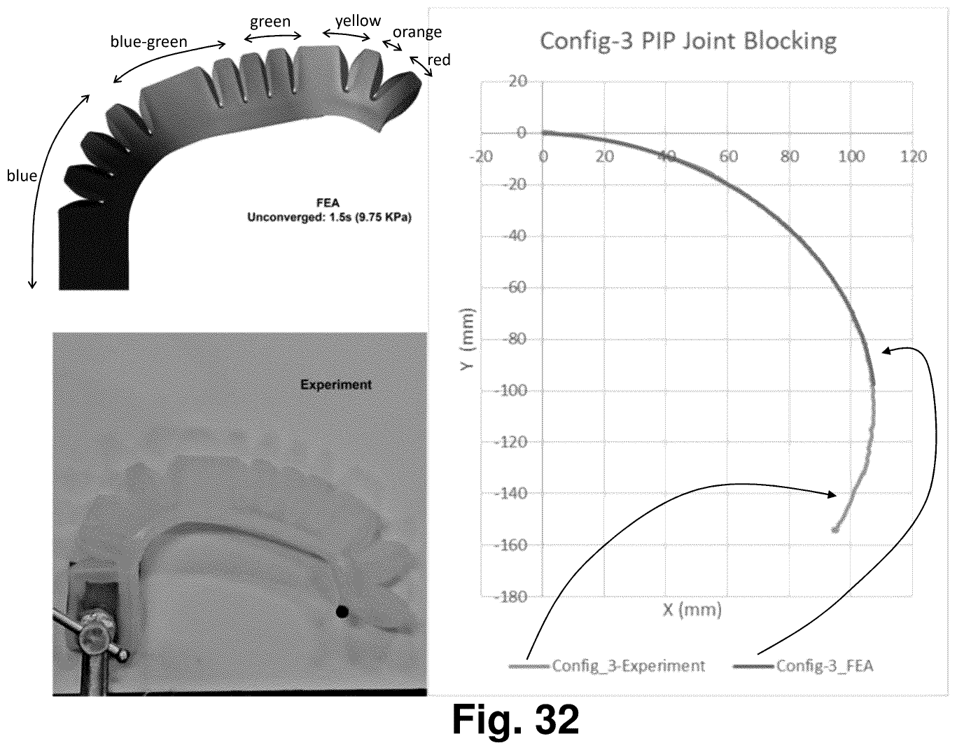

At least one deformation experiment was conducted consisting of three configurations as displayed in FIG. 1. Configuration 1 performed the actuation with no joint-blocking as shown in FIG. 30. Next, Configuration 2 performed the actuation with the MCP joint-blocking as shown in FIG. 31. And, Configuration 3 performed the actuation with PIP joint-blocking as shown in FIG. 32. Air was supplied to the actuator through a Teflon tube regulated to a pressure of 25 kPa.

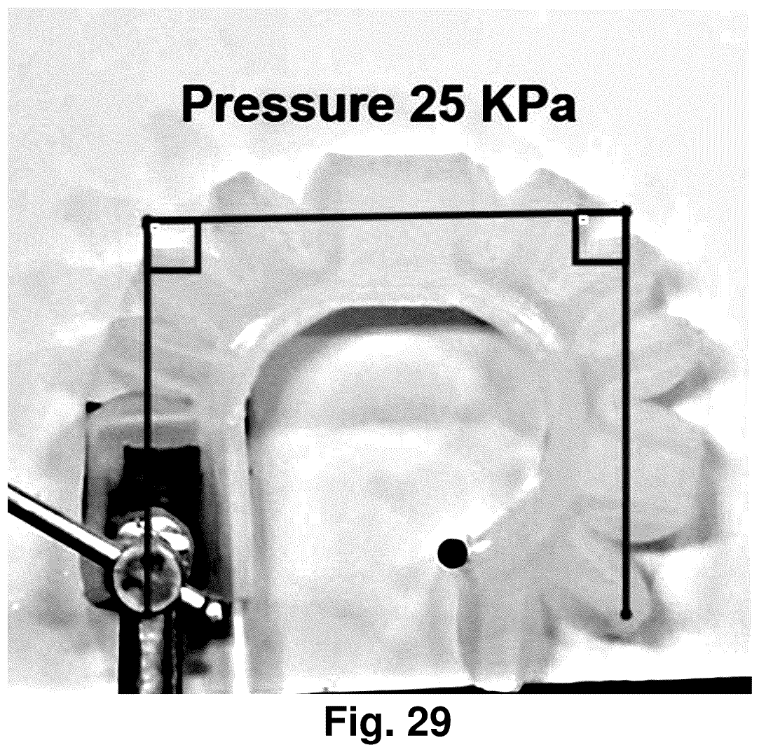

The angles of the PneuNet-type actuators above the MCP and PIP joints were manually set to 90 degrees by adjusting the input pressure. The corresponding pressure measured from the pressure sensor was set to the experimental operation pressure for all three configuration tests. FIG. 29 shows how the pressure value was set to 25 kPa for the experiment of VSSA-2 deformation.

The data for the experimental tip trajectory of the VSSA-2 in the three configurations of the experiments was gathered through a visual method. A camera was set above the VSSA-2 to record the deformation. A black dot tracking point was placed at the tip of the actuator. The tracking point was then used to calculate the tip trajectory of the actuator using a Python script running OpenCV. A meter rule was also used to scale the pixels to mm to allow proper transformation of the pixel values of the tracking point trajectory to mm, enabling a direct comparison with the FEA simulations. At the start of the experiment, the pneumatic valve supplying air to the VSSA-2 was slowly opened to allow the air pressure to slowly build up in the VSSA-2. As the VSSA-2 actuator pressurized, video of the actuator deformation was recorded.

The results for Configuration 1 shown in FIG. 30 include the finite element analysis (FEA) simulation on the top left, the experiment on the bottom left, and the plotted deformation for both. The plot sets the undeformed position of the VSSA-2 as the origin point. The result showed that the FEA simulation and experiment endpoints for Configuration 1 were (56.15, −163.25 mm) and (43.87, −162.15 mm) in the X/Y 2D-planner axes respectively. The slight separation of the two curves 91 below the −80 mm mark can be attributed to inconsistencies in the surface lubrication of the backboard.

The results for Configuration 2 shown below in FIG. 31 present the FEA simulation on the top left, the experiment on the bottom left, and the plotted deformation for both. The plot sets the undeformed position of the VSSA-2 as the origin point. The result showed that the FEA simulation and experiment endpoints for Configuration 2 were (71.93, −96.27 mm) and (63.93, −108.96 mm) in the X/Y 2D-planner axes respectively.

The results for Configuration 3 shown in FIG. 32 present the FEA simulation on the top left, the experiment on the bottom left, and the plotted deformation for both. The plot sets the undeformed position of the VSSA-2 as the origin point. The result showed that the FEA simulation and experiment endpoints for Configuration 3 were (107.35, −97.41 mm) and (95.14, −154.35 mm) in the X/Y 2D-planner axes respectively. A key item to note for this configuration was that the FEA simulation did not fully converge. All efforts led to a maximum convergence of the model until the input pressure was 9.75 kPa. The limitations were caused due to computational processing capability as the appointed number of cores (20 cores) of the CPU were unable to solve for increased mesh density in the FEA model.

Furthermore, the results for Configurations 0, 1 and 2 showed that the deformation (angle) of the experiment was slightly greater (angle) than the FEA simulations following along the trajectory of the actuator. The increased travel of the experimental trajectory was attributed to improper calibration of the pressure gauge. Anecdotally, the preliminary results with the test models showcased that a similar tip deformation of the VSSA-2 was achieved by an input air pressure of 120 kPa while the FEA simulation was performed at 23 kPa. The difference between the experimental and simulated input pressures of the original VSSA-1 design was an increase of the actuation pressure by 421.7% (percentage error between the FEA and experimental values). The increased air pressure requirement was caused by the air leaks from the VSSA expansion chambers. The VSSA-2 results showed the actuator deformed to a similar point between the FEA and experiment with an increase of the actuation pressure by 81.2%. The change in actuation pressure in the FEA simulations and experiments between the VSSA-1 design and the VSSA-2 is attributed to the change in the design and material used. The air pressure required for the actuation between the two designs decreased by 41.3% for the FEA simulations and 79.2% for the experiments. The decrease in the percentage error by 340.5 percentage points between the simulations and experiments of the VSSA-1 and VSSA-2 is attributed to the improved fabrication method of the VSSA-2. The molding fabrication method employed in VSSA-2 reduced the amount of air leakage from the actuator by providing a homogenous bond of the silicone material in the VSSA-2 expansion chambers (PneuNet-type actuators).

The deviation between the FEA simulation and actual experiment actuation pressure hindered the one-to-one comparison between the simulated and experimental data points. Having only the final pressure point for the experiments prevented to direct comparison of the data points on the FEA and experimental curves based on pressure points. To address this issue, a third curve was created by interpolating the X-axis values of the experiment data with constant Y-axis data points between the FEA and experimental data. The curve ensures a direct and meaningful comparison between the experimental and FEA data points. Interpolation is a mathematical method used to estimate unknown values that fall within the range of a set of known data points. In this study, linear interpolation was implemented, assuming a straight-line relationship between adjacent data points. Specifically, the experimental X-values were interpolated by considering pairs of adjacent experimental data points and estimating the corresponding X-value for each FEA Y-value. The adjacent data points used were plugged in the following equation to obtain the interpolated X-values.

$${x}_{interpolate} = {x}_{1} + \frac{( {x}_{2} - {x}_{1} )}{( {y}_{2} - {y}_{1} )} * ( {y}_{interpolate} - {y}_{1} )$$

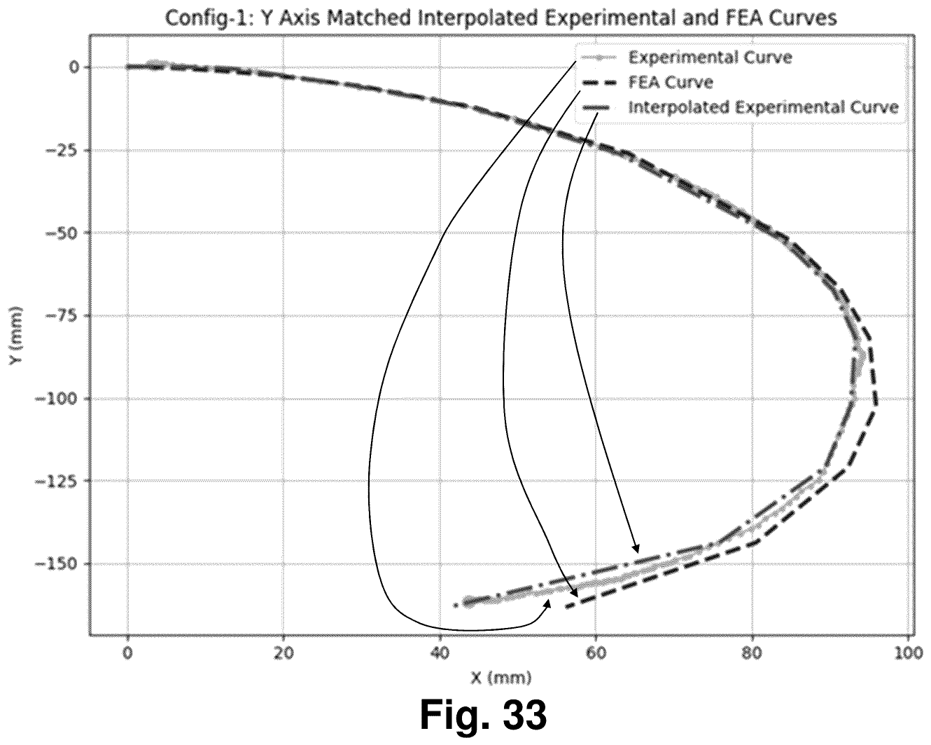

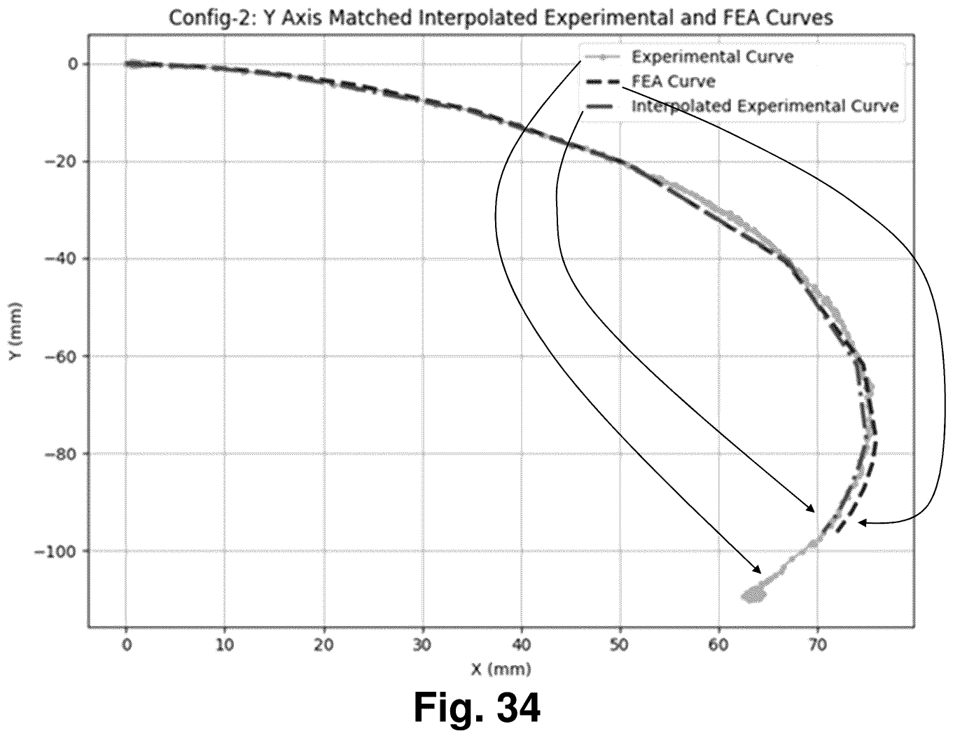

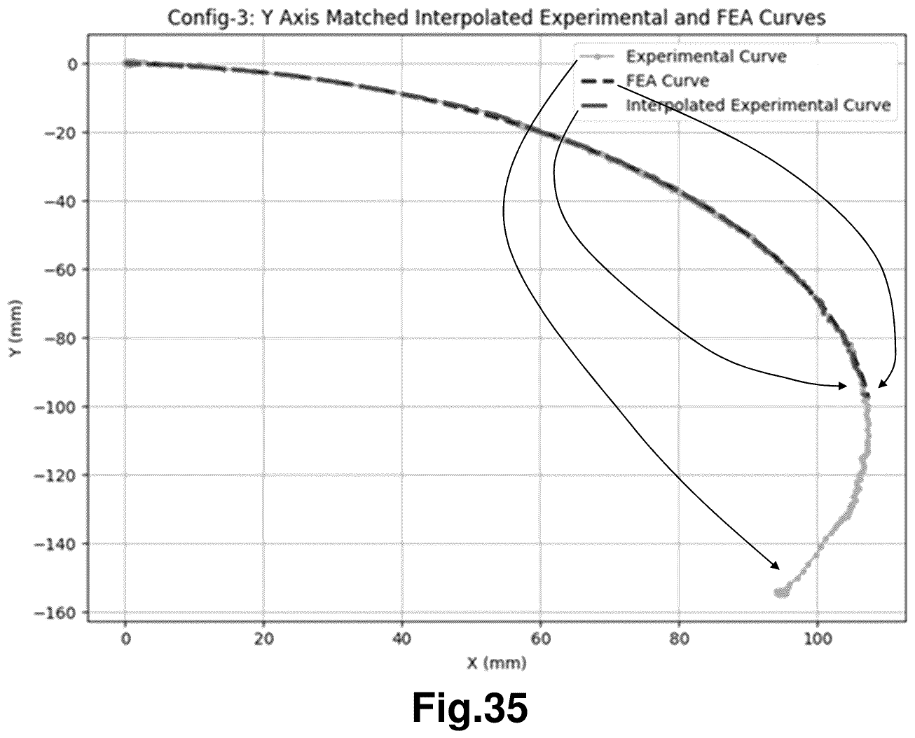

Interpolating the X-values of the experimental data preserved the continuity and trends of the experimental data while enabling direct alignment with the FEA Y-values. The alignment ensured that both datasets have the same Y-values, enabling direct comparison of their X-values. The FEA, experimental, and interpolated curves for the three configurations of the experiment are showcased in FIGS. 33-35.

The comparisons used are the Root Mean Square Error (RMSE), the maximum, mean, and median difference, and the standard deviation. The RMSE highlighted differences by quantifying the average size of the differences between the two datasets. The RMSE method was used to measure the differences between values calculated by the model (mathematical or FEA) and the actual experimental values. The RMSE provides an overall measure of the alignment quality, with lower values indicating better agreement. The RMSE of the interpolated and FEA X-axis values can be calculated using the equation below.

$$RMSE = \sqrt{\frac{1}{n} {\sum }_{i = 1}^{n} {( {x}_{interpolate , i} - {x}_{fea , i} )}^{2}}$$

An alternative method used for direct comparison between the interpolated and FEA curves was by using the maximum, mean, and median differences. The maximum absolute difference identified the largest deviation between the two datasets, highlighting extreme cases. The mean difference represents the average offset between the two datasets. The maximum and mean differences are defined as shown in the upper equation below and the lower equation below, respectively.

$$\begin{matrix}{Δ}_{max} = max ( \vert {x}_{interpolate} - {x}_{fea} \vert ) \\ {Δ}_{mean} = \frac{1}{n} {\sum }_{i = 1}^{n} ( {x}_{interpolate} , i - {x}_{fea , i} )\end{matrix}$$

The median difference was measured as the middle value of the differences when sorted, providing a robust measure of central tendency that is less sensitive to outliers. Combining these differences with the standard deviation of the interpolated and FEA curves, a box plot for each configuration was generated to provide a comprehensive visual summary of the data analysis. The standard deviation is calculated based on the below equation.

$${σ}_{Δ} = \sqrt{\frac{1}{n} {\sum }_{i = 1}^{n} {( ( {x}_{interpolate , i} - {x}_{fea , i} ) - {Δ}_{mean} )}^{2}}$$

The metrics collected by applying all the data comparison methods mentioned above are summarized in Table 3 below.

TABLE 3
FEA and interpolated experiment X-axis data
comparison for the 3 configurations

| Metric | Configuration 1 | Configuration 2 | Configuration 3 |
|---|---|---|---|
| RMSE | 4.953 | 1.314 | 0.400 |
| Maximum | 15.024 | 3.305 | 2.624 |
| Difference | | | |
| Mean Difference | −0.6260 | −1.042 | −0.166 |
| Median Difference | 2.337 | 1.011 | 0.246 |
| Standard | 3.614 | 0.763 | 0.281 |
| Deviation | | | |

The data on each of the configurations were compared, showing consistency in the values that were retrieved and in the visual representation of the FEA and interpolated experiment curves. Configuration 1 was found to have a relatively high RMSE value of 4.953 with a mean difference value of −0.626. The values suggested that the interpolated experimental X-axis values deviated from the FEA X-axis values. The low negative mean difference was attributed to the slight left bias in the interpolated experimental X-axis values after the 80 mm mark. Configurations 2 and 3 were found to exhibit very similar metrics with relatively low values of RMSE and mean difference. The data indicated that the dataset from the curves was closely aligned but had a slight systemic offset.

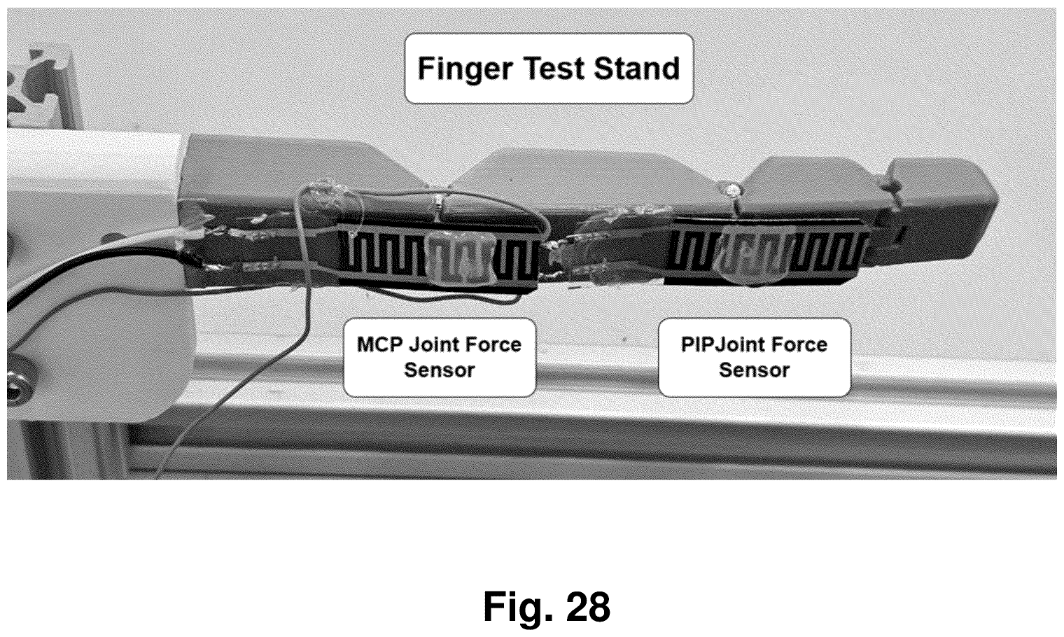

A performance experiment of the VSSA-2 was conducted and involved using the actuator on a test stand finger with the three configurations and collecting the force feedback data. The force feedback data was collected on the MCP and PIP joints. The tip force applied by the extended actuator was also collected using a calibrated force transducer. The VSSA-2 was mounted to a glove and attached to the test stand finger shown in FIG. 28. The actuation source used for the experiments was the air supply of the CAHRD. The CAHRD air supply was set to the lowest power level for all the experiments and was used on the VSSA-2 and CAHRD glove. The VSSA-2 performed three tests with the actuator configurations described in the previous test while the CAHRD only performed one test in the default configuration. FIG. 18 shows a sample of how the experiment was conducted on the test finger stand with the VSSA-2 mounted to a glove.

Before the experiments were conducted, the force sensors on the MCP and PIP joints were calibrated using a MARK-10 Series 5 machine. The force sensors were pressed with a force of 19.1 N for the MCP finger joint and 19.8 N for the PIP finger joint. The corresponding analog values recorded by the microcontroller were then scaled accordingly. The MARK-10 was pressed against the silicone pad on the force sensors to ensure an even distribution of the force which provided reliable readings.

The maximum values recorded by the microcontroller analog ports from the force sensors were 429 for the MCP joint and 442 for the PIP joint. The corresponding scaling factors for the MCP and PIP joint force sensors were then calculated to be 0.044522 N/ADC and 0.044796 N/ADC, resulting in peak forces of 19.1 N and 19.8 N, respectively.

The experiment for the performance of CAHRD and three configurations of the VSSA-2 on the finger test stand were conducted and the force feedback from the send MCP and PIP force sensors was recorded. Each test was conducted five times with the actuator sweeping from 0 air pressure to the low level on the CAHRD air supply. After collecting five data sets of the ADC value of the MCP and PIP force sensor for each configuration of the experiment, the average values for the tests were determined. The scaling factors for the respective MCP and PIP joints were then applied to the ADC value to get the force feedback data from the sensors. The results from the CAHRD were only compared against Configuration 1 of the VSSA-2 as the joint blocking feature is not available on the CAHRD. Configuration 1 of the VSSA-2 was also compared to Configurations 2 and 3.

The results indicated that with the same input pressure, different operation profiles for the force feedback were produced by the CAHDR and VSSA-2. A force spike was produced by the CAHDR on the PIP joint in the beginning and was maintained throughout the actuation motion. The same amount of force was shortly (after 60 readings) applied to the MCP joint as well. A roughly equal force of 7.6 N for the MCP finger joint and 7.1 N for the PIP finger joint was maintained by both joints at the end of the actuation motion. The same input actuation pressure on the VSSA-2 produced a response where the force on the PIP and MCP joints gradually increased. A slight delay was observed in the reaction force on the MCP joint from the PIP joint. The MCP and PIP force joints reached their corresponding maximum values at the end of the actuation motion, with values of 7.6 N and 9.6 N, respectively. Additionally, the response of both joint forces on the VSSA-2 was found to be slightly delayed (10 readings for the MCP and 25 readings for the PIP joint) compared to the CAHDR. The delay in the VSSA-2 response forces was attributed to a slower expansion rate of the VSSA. The delayed response of the VSSA-2 was thought to be caused by the different styles of actuators in the CAHDR and VSSA-2 (bellows and PneuNet-type actuators). At least one reason for this was considered to be the larger internal volume and surface area of the VSSA-2 PneuNet-type actuators compared to the bellows-actuators of the CAHDR. The larger surface area on the VSSA-2 PneuNet-type actuators was also found to result in a greater actuation force. A direct comparison of the MCP and PIP joint forces of the VSSA-2 and CAHDR showed a 30% difference in the PIP joint forces, while the MCP joint forces were found to have remained unchanged.

Blocking the MCP joint in Configuration 2 showed no force on the joint. The PIP joint in Configuration 2, however, followed the same force feedback profile as Configuration 1 with a maximum value of 10.1 N. Finally, Configuration 3 of the VSSA-2 blocked the PIP joint and produced a force feedback response profile in which both the MCP and PIP joints had a reaction force at the same time but to a reduced value of 6 N and 4 N respectively. The last 5 data points on the PIP joint in configuration 3 fluctuated by 1 N, likely due to sliding occurring within the glove. Therefore, the average reading of 4 N was taken as the PIP joint reaction force at the end of the actuation motion.

Further comparison of the VSSA-2 and CAHRD required the finger-tip force data to be collected using a MARK-10 force transducer. The VSSA-2 and CAHRF glove with the test finger were placed under the force transducer and held at a constant location by a vice. The MARK-10 force transducer was lowered to 2 mm above the actuator and the force scale was zeroed. Next, the actuation pressure was applied (lowest setting on the CAHRD air supply) and the resultant maximum force applied by the actuator was measured.

The results of the testing revealed that the VSSA-1 and VSSA-2 configurations were effective for had rehabilitation. By incorporating the variable stiffness technology addressed herein, embodiments of the present disclosure were able to overcome limitations of prior technology, such as the inability of the prior technology to perform complex alternative joint-blocking therapies. By incorporating the variable stiffness technologies disclosed herein, the VSSAs enabled precise manipulation of finger joint stiffness, facilitating diverse grip patterns and improving rehabilitation outcomes for stroke patients.

The research into the VSSA-1 and VSSA-2 configurations was conducted in two iterative phases of actuator design. the configurations were developed using additive manufacturing and silicone molding techniques, enabling soft and compliant structures suitable for human-robot interaction. Experimental tests and comparative analyses against commercially available hand rehabilitation devices (e.g., CAHRD) revealed significant improvements in versatility and functionality, particularly in enabling alternative grip patterns.

The significant advancements enabled by the application of variable stiffness technology in rehabilitation devices, particularly in exoskeleton gloves for hand therapy, were demonstrated with the prototypes that were tested. The limitations of existing devices, which primarily relied on uniform motions and lacked the capability to execute complex joint-specific therapies, were successfully addressed. The VSSA-1 and VSSA-2 actuators were shown to have the ability to perform multiple alternative rehabilitation therapies. By targeting specific joints while allowing precise motion control, substantial improvements over traditional methods are offered by embodiments of the present disclosure.

The functionality and user adaptability of the VSSA designs were enhanced by ergonomic considerations. Natural finger movements were replicated and stiff regions above joints were integrated, leading to improved comfort and efficiency in therapy applications. Despite initial challenges with air leakage in 3D-printed components (especially in the VSSA-1 configuration), these issues were resolved by the transition to silicone molding, ensuring consistent performance. Comparisons with a commercially available hand rehabilitation device (CAHRD) were made, highlighting the superior ability of the VSSA designs to exert force and provide joint-specific motion, indicating that the VSSA embodiments of the present disclosure are effective solutions for personalized stroke rehabilitation.

Beyond rehabilitation, the potential applications of the VSSA technology extend to assistive devices, such as prosthetics, and even to industrial use cases requiring precise, compliant motion control in soft robotics. The versatility of this technology underscores its potential across multiple domains, paving the way for innovations that can significantly improve both rehabilitative care and other fields requiring variable stiffness soft mechanical systems

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### ELEMENT NUMBERING

Table 4 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 4

100
200

What is claimed is:

1. A variable stiffness soft actuator, comprising:
a horizontally disposed base defining a horizontally disposed slider chamber;
a plurality of vertically disposed chambers defining a lower portion, the lower portion being connected to the base, wherein
the base restricts horizontal movement of the lower portion of the vertically disposed chambers and
increasing pressure within the vertically disposed chambers results in the base bending; and
a stiffness beam disposed within the slider chamber and configured to be selectively movable within the slider chamber;
wherein the stiffness beam inhibits bending of the base in the region of the slider chamber occupied by the stiffness beam.

2. The variable stiffness soft actuator of claim 1, wherein the plurality of vertically disposed chambers are pneumatic chambers configured to be filled with a gas.

3. The variable stiffness soft actuator of claim 1, wherein the plurality of vertically disposed chambers
define an upper portion opposite the lower portion, and
are alternatingly connected to one another at the upper and lower portions forming a single sinusoidally-shaped chamber.

4. The variable stiffness soft actuator of claim 1, wherein the plurality of vertically disposed chambers are interconnected at the lower portions of the individual chambers.

5. The variable stiffness soft actuator of claim 4, wherein the plurality of vertically disposed chambers include at least one stiff chamber that is
wider in the horizontal direction than the other of the plurality of vertically disposed chambers, and
is at least partially filled with a solid material.

6. The variable stiffness soft actuator of claim 1, wherein the plurality of vertically disposed chambers
define an upper portion opposite the lower portion, and
the upper portion is less restricted in horizontal movement than the lower portion.

7. The variable stiffness soft actuator of claim 1, further comprising:
a motorized pulley; and
a closed-loop cable connected to the pulley and the stiffness beam, wherein rotation of the motorized pulley moves the stiffness beam within the slider chamber.

8. The variable stiffness soft actuator of claim 1, wherein the plurality of vertically disposed chambers externally resemble a corrugated shape.

9. The variable stiffness soft actuator of claim 1, further comprising:
an air reservoir pneumatically connected to the plurality of vertically disposed chambers, wherein the air reservoir is configured to increase pressure within the vertically disposed chambers.

10. A method of actuating a rehabilitative system, comprising the steps of:
bending an actuator by adjusting the pressure of a fluid or gas being supplied to the actuator;
inhibiting the bending of a portion of the actuator by locating a stiffness beam within a slider channel in the actuator, wherein the stiffness beam inhibits bending of the actuator in the vicinity of the stiffness beam.

11. The method of claim 10, wherein said adjusting the pressure of a fluid or gas includes the fluid or gas entering a plurality of vertically disposed chambers.

12. The method of claim 11, further comprising:
inhibiting a lower portion of the vertically disposed chambers to move horizontally in relation to one another while allowing an upper portion of the vertically disposed chambers to move horizontally in relation to one another.

13. The method of claim 11, wherein said adjusting the pressure of a fluid or gas includes the fluid or gas entering a sinusoidally-shaped chamber formed by the plurality of vertically disposed chambers being alternatingly connected to one another at upper and lower portions of the vertically disposed chambers.

14. The method of claim 11, wherein said adjusting the pressure of a fluid or gas includes the fluid or gas entering each of the vertically disposed chambers from a lower portion of each of the vertically disposed chambers.

15. The method of claim 10, further comprising:
changing the location of said inhibiting by adjusting the location of the stiffness beam within the slider channel.

16. The method of claim 15, wherein said changing the location includes actuating a pulley and cable system connected to the stiffness beam.

17. A variable stiffness actuator system, comprising:
a horizontally disposed base;
a plurality of vertically disposed chambers defining a lower portion, the lower portion being connected to the base, wherein
the base restricts horizontal movement of the lower portion of the vertically disposed chambers and
increasing pressure within the vertically disposed chambers results in the base bending; and
means for inhibiting the bending of the base at a user-selectable location while permitting the bending of the base at other locations.

18. The variable stiffness actuator system of claim 17, wherein
the horizontally disposed based defines a horizontally disposed slider chamber,
a stiffness beam disposed within the horizontally disposed slider chamber inhibits bending of the base in the region of the slider chamber occupied by the stiffness beam, and
said means includes positioning a stiffness beam disposed within a slider chamber at a user-selectable location within the slider chamber.

19. The variable stiffness actuator system of claim 18, wherein the plurality of vertically disposed chambers
define an upper portion opposite the lower portion, and
are alternatingly connected to one another at the upper and lower portions forming a single sinusoidally-shaped chamber.

20. The variable stiffness actuator system of claim 18, wherein
the plurality of vertically disposed chambers are interconnected at the lower portions of the individual chambers,
the plurality of vertically disposed chambers include at least one stiff chamber that is wider in the horizontal direction than the other of the plurality of vertically disposed chambers and is at least partially filled with a solid material.
